(19) United States
(12) Patent Application Publication
(10) Pub. No.: US 2019/0041217 A1
(43) Pub. Date: Feb. 7, 2019

(54) STAR TRACKER FOR MOBILE APPLICATIONS

(71) Applicant: ARIEL SCIENTIFIC INNOVATIONS LTD., Ariel (IL)

(72) Inventors: Boaz BEN-MOSHE, Herzliya (IL); Nir SHVALB, Kibutz Bahan (IL); Revital MARBEL, Kfar Tapuah (IL)

(21) Appl. No.: 16/056,831

(22) Filed: Aug. 7, 2018

Related U.S. Application Data
(60) Provisional application No. 62/541,876, filed on Aug. 7, 2017.

(51) Int. Cl. G01C 21/02; G06T 7/73

(52) U.S. Cl. CPC G01C 21/025; G06T 7/50; G06T 2207/10016; G06T 7/73

(57) ABSTRACT

A method for star tracking, the method comprising using at least one hardware processor for receiving at least one digital image at least partially depicting at least three light sources visible from the at least one sensor, wherein the at least one sensor captured the at least one digital image. The method comprises an action of processing the at least one digital image to calculate image positions of the depicted at least three light sources in each image. The method comprises an action of identifying the at least three light sources in each image by comparing a parameter computed from the at least one image and a respective parameter computed from a database. The method comprises an action of determining a position of the at least one sensor based on the identified at least three light sources.

### CROSS-REFERENCE TO RELATED APPLICATIONS

This application claims priority to U.S. Provisional Patent Application No. 62/541,876, filed Aug. 7, 2017, entitled “Star Tracker for Mobile Applications”, the contents of which are incorporated herein by reference in their entirety.

### FIELD OF THE INVENTION

The invention relates to the field of celestial navigation.

### BACKGROUND

Star tracking devices provide positioning information, such as location for a space vehicle, attitude for satellite control, and/or the like. Star trackers may be more accurate and reliable than devices based on alternative technologies, such as global positioning systems, inertial positioning systems, and/or the like. Star trackers allow for attitude estimation without prior positioning information.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method for celestial navigation, the method comprising using at least one hardware processor for receiving at least one digital image at least partially depicting at least three light sources visible from at least one sensor, wherein the at least one sensor captured the at least one digital image. The method comprises an action of processing the at least one digital image to calculate image positions of the depicted at least three light sources in each image. The method comprises an action of identifying the at least three light sources in each image by comparing a plurality of geometric parameters computed from the at least three light sources and a respective plurality of geometric parameters computed from a database of light sources. The method comprises an action of determining a position of the at least one sensor based on the identified at least three light sources.

In some embodiments, the at least one digital image is at least in part a frame of a video steam, a video file, and a live video cast.

In some embodiments, the plurality of geometric parameters are at least one of an angle, a solid angle, a distance, and a geometric relationship.

In some embodiments, the at least one sensor is a member of the group consisting of an optical sensor, a camera sensor, an electromagnetic radiation sensor, an infrared sensor, and a two-dimensional physical property sensor.

In some embodiments, the light source is from a member of the group consisting of a roadway light, an astronomical body, a man-made space object, such as a satellite, and a man-made aerial object, such as an atmospheric balloon.

In some embodiments, the position is at least one of a location, an orientation, a distance, and a geometric relationship.

In some embodiments, the position comprises at least one positioning value.

In some embodiments, the at least one hardware processor is incorporated into at least one system from the group consisting of a laser aiming system, an antenna aiming system, a camera aiming system, and a position computation system.

In some embodiments, the actions of the method are implemented when global navigation satellite systems are unavailable for positioning.

There is provided, in accordance with an embodiment, a system for star tracking comprising at least one hardware processor, and a non-transitory computer-readable storage medium having program code embodied therewith. The program code is executable by said at least one hardware processor to receive at least one digital image at least partially depicting at least three light sources visible from the at least one sensor, wherein the at least one sensor captured the at least one digital image. The program code is executable by said at least one hardware processor to process the at least one digital image to calculate image positions of the depicted at least three light sources in each image. The program code is executable by said at least one hardware processor to identify the at least three light sources in each image by comparing a parameter computed from the at least one image and a respective parameter computed from a database. The program code is executable by said at least one hardware processor to determine a position of the at least one sensor based on the identified at least three light sources.

There is provided, in accordance with an embodiment, a computer program product for star tracking, the computer program product comprising a non-transitory computer-readable storage medium having program code embodied therewith. The program code is executable by said at least one hardware processor to receive at least one digital image at least partially depicting at least three light sources visible from the at least one sensor, wherein the at least one sensor captured the at least one digital image. The program code is executable by said at least one hardware processor to process the at least one digital image to calculate image positions of the depicted at least three light sources in each image. The program code is executable by said at least one hardware processor to identify the at least three light sources in each image by comparing a parameter computed from the at least one image and a respective parameter computed from a database. The program code is executable by said at least one hardware processor to determine a position of the at least one sensor based on the identified at least three light sources.

In addition to the exemplary aspects and embodiments described above, further aspects and embodiments will become apparent by reference to the figures and by study of the following detailed description.

### BRIEF DESCRIPTION OF THE FIGURES

The patent or application file contains at least one drawing executed in color. Copies of this patent or patent application publication with color drawing(s) will be provided by the Office upon request and payment of the necessary fee.

Exemplary embodiments are illustrated in referenced figures. Dimensions of components and features shown in the figures are generally chosen for convenience and clarity of presentation and are not necessarily shown to scale. The figures are listed below.

FIG. 1 shows schematically a system for mobile star tracking;

FIG. 2 shows a flowchart of a method for mobile star tracking;

FIG. 3 shows an identification of a star pattern in two different digital images;

FIG. 4 shows schematically the main components of a star tracking framework;

FIG. 5 shows a screen of user interface with a star tracking and a mobile camera orientation (pose);

FIG. 6 shows a graph of accuracy level (AL) for mobile star tracking;

FIG. 7 shows a graph of AL and load factor ratio for a mobile star tracking;

FIG. 8 shows a graphic representation of Gauss's distribution of standard distance deviation error (err) around the stars;

FIG. 9 shows a graph of the AL and distribution effect on right matching probability;

FIGS. 10A-10B show pixel distance deviations on an undistorted frame (FIG. 10A) and a distorted frame (FIG. 10B);

FIG. 11 shows a visual explanation for the confidence calculation process;

FIG. 12 shows a star possible location in the catalog according to its closest stars;

FIG. 13 shows two frames of the Orion constellation from different locations;

FIG. 14 shows a graph of the angular distance gap between two stars;

FIG. 15 shows a graph of the confidence threshold for true match in AL 0.01;

FIG. 16 shows a graph of the confidence threshold for true match in AL 0.05;

FIG. 17 shows a screenshot of a Nexus 5x android device with implementation of the star-tracker algorithm;

FIGS. 18A-18D show images recorded with star-detection application capture by a Samsung Galaxy S6 android device;

FIG. 19 shows an image of the Orion constellation as it appears in the Yale Bright Stars Catalog (YBS) via the Stellarium system;

FIG. 20 shows an image recorded with star-detection application capture by a Samsung Galaxy S9 device;

FIGS. 21A-21D show four enlarged frames of the image of FIG. 20;

FIGS. 22A-22B show the star-tracker algorithm implementation on Samsung Galaxy S9;

FIGS. 23A-23C show images captured with a Raspberry Pi, with a standard RP v2.0 camera; and

FIGS. 24A-24G show images captured with a star tracking device.

### DETAILED DESCRIPTION

Disclosed herein are systems, methods, and computer program products for star tracking on client terminals equipped with a camera, such as a standard, off-the-shelf camera. A camera viewing direction is estimated using an image of the stars that was taken from that camera, such as a still digital image, a frame of a video file, a frame of a real-time video stream, and/or the like. The high-level steps are:

Detection of star center locations in the image with sub-pixel accuracy.

Assigning a unique catalog identification (ID) or a false tag to each detected star.

Calculation of the camera viewing direction from the detected stars.

The input may be a noisy image or images, such as video frames, of at least part of the night sky. The first step focuses on the extraction of the navigational stars from the image(s). The second step identifies the stars, for example by their unique ID. The ID may be obtained from a-priori lists, such as the Hipparcos (HIP) catalog provided by NASA, the Tycho catalog, the Henry Draper Catalogue, the Smithsonian Astrophysical Observatory catalogue, and/or the like. This step's output is a list of all the visible stars in the image with their names (string) and their positions (x and y coordinates within the image). Star location registration may be performed between the captured image and the known star positions obtained from the catalog using each star's data and comparing between stars.

Optionally, in addition to each star's data in the database, there are computed other relational and/or positional parameters between star pairs, triplets, or the like, such as the computed angle between pairs of stars (based on the sensor and image collection parameters), the chromatic difference, the spectral difference, the solid angle, angular volume, and/or the like. For example, the angle or solid angle between any two or more stars remains the same (neglecting measurement errors) in the image. For example, the angles and distances between any three or more stars (such as described by the polygon defined by the stars) is a unique indication of sensor pose and global position, and determined by comparing the polygon values with similar polygons of a star database. For example, the spectral difference is one or more value the is computed from a spectral plot of the “light” received from each star. A naive algorithm of searching the database for the known angles and/or other data may be time consuming since there may be many stars in the catalog (over 30,000 items). The computational efficiency may be improved by utilizing a gird-based search or the like.

Optionally, sun tracking may be performed. In sun tracking, an algorithm may be less complex and simple to perform. The tracking may be done by identifying the sun in the image and calculate its position relative to the device while taking in consideration the sun orbit, the approximate location of the device and the current time.

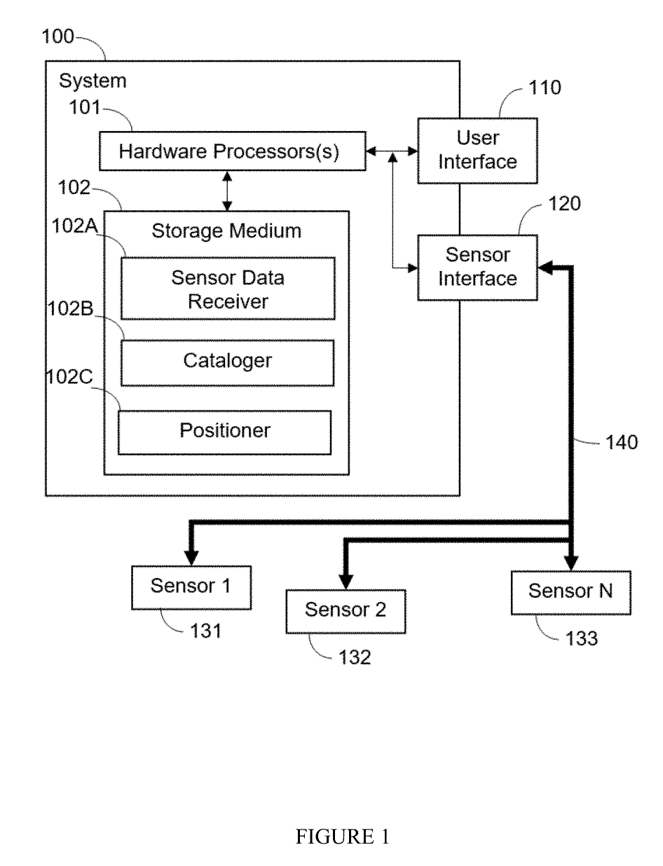

Reference is now made to FIG. 1, which shows schematically a system 100 for mobile star tracking System 100 comprises at least one hardware processor 101, a storage medium 102, a network interface 120, and a user interface 110. Storage medium 102 has encoded thereon program code which comprises modules of processor instructions that are configured to perform actions when executed on hardware processor(s) 101. Program code includes a Sensor Data Receiver 102A which comprises instructions that may receive an image, frame, video, or the like, and compute two or more light sources in the image, where the light source comprises at least one object value, and an object image position. Sensor Data Receiver 102A receives images from one or more sensors 131, 312, and 133, through a sensors network 140 and sensor network interface 120. For example an internal sensor is accessed by an interface data bus. A Cataloger 102B which comprises instructions that identify the light sources in a database of light sources, such as by a geometric parameter computed respectively from the light source image positions and the database record values. The instructions included in a Positioner 102C are configured to compute a position based on the identified light sources.

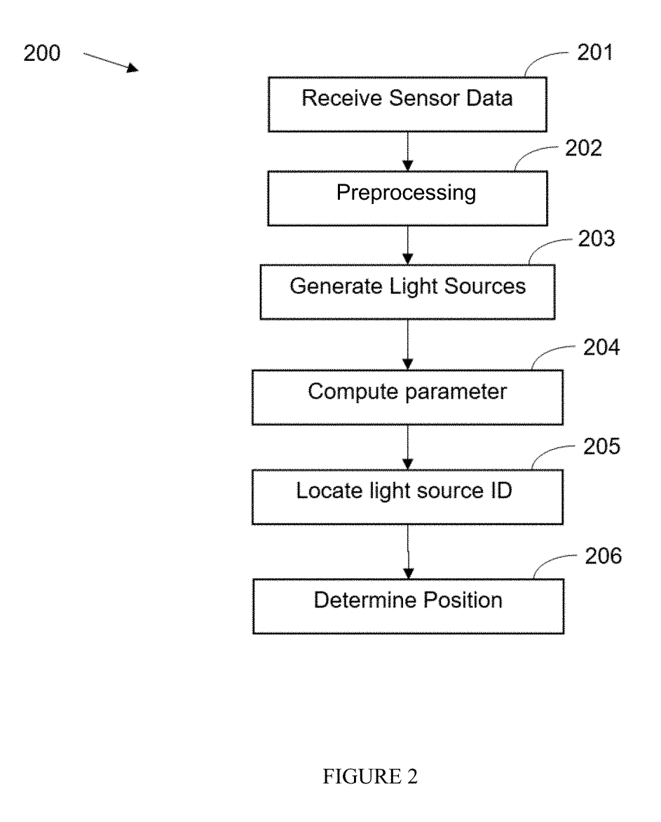

Reference is now made to FIG. 2, which shows a flowchart of a method 200 for automatic mobile star tracking using hardware processor(s) 101. Sensor data is received 201 automatically from one ore more sensors 131, 132, and 133 that are part of network 140 through the sensor interface 120. Preprocessing 202 may automatically correct image aberrations that are fixed for each sensor, and may remove noise and or artifacts from the image(s). A list of light sources in the image is then automatically generated 203 by computing objects depicted in the image(s). One or more parameters may be automatically computed 204 based on the depicted light sources and the sensor operational parameter values, for example 3D angles between light source pairs depicted in the image. The parameter(s) are automatically located 205 in the light source database by either computing corresponding parameters from the database of using precomputed parameters stored in the database. The identified light sources may be used to automatically determine 206 a position, orientation, pose, or the like of the sensor(s).

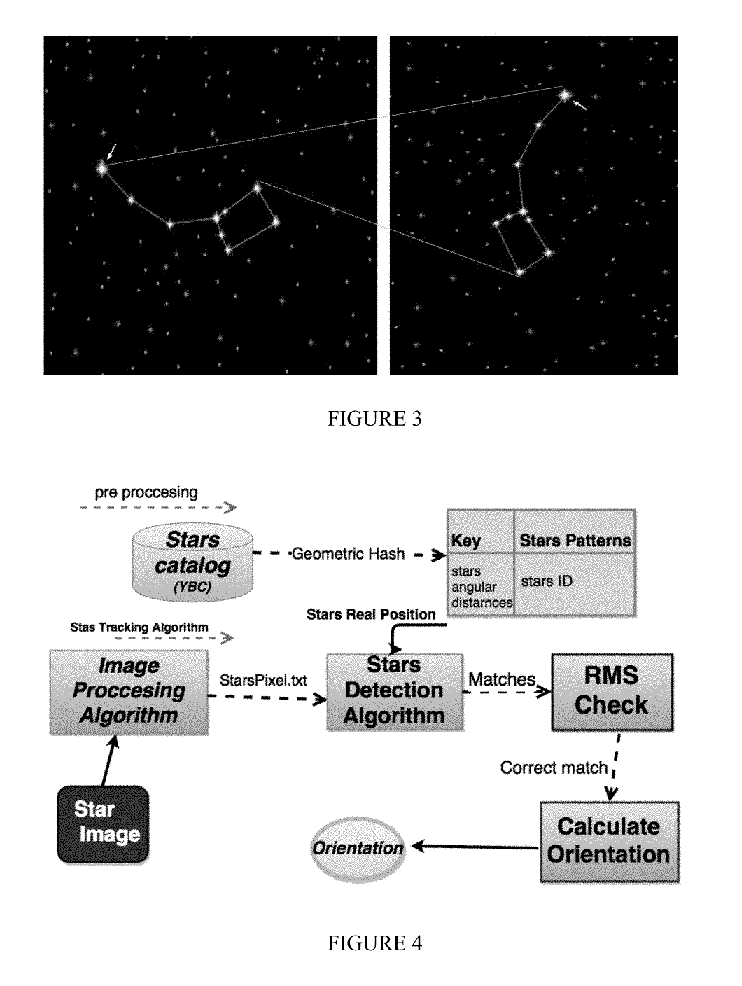

Reference is now made to FIG. 3, which shows an identification of a star pattern in two different digital images. The identified star patterns in each image correspond to different camera poses of the respective two images demonstrated during a registration phase. The same stars in both images are identified and star pattern registration between two images is performed. The respective angles computed between the star pairs remain the same regardless of the camera orientation.

Reference is now made to FIG. 4, which shows schematically the main components of a star tracking framework.

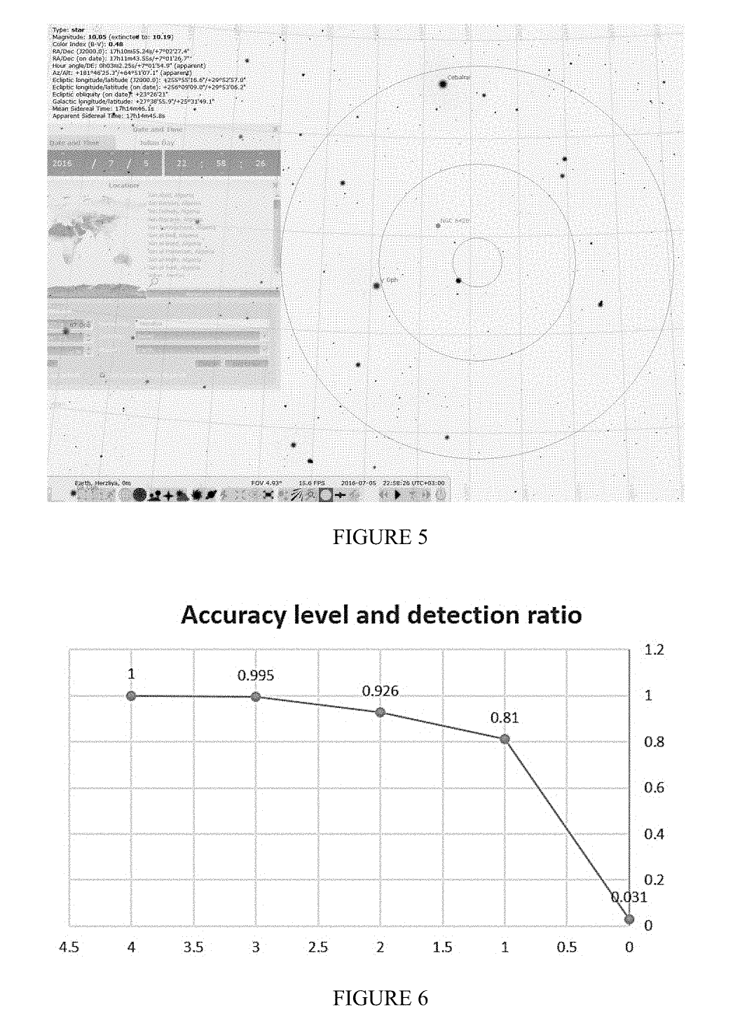

Reference is now made to FIG. 5, which shows a screen of user interface with a star tracking and a mobile camera orientation (pose). The image of the night sky is presented by the Stellarium tool along with the camera pose and identified stars.

Reference is now made to FIG. 6, which shows a graph of accuracy level (AL) for mobile star tracking. Accuracy level and star detection ratio are shown in the graph, where the x-axis represents the accuracy level values, and the y-axis represents the ratio between all keys in the database and the candidate light source patterns.

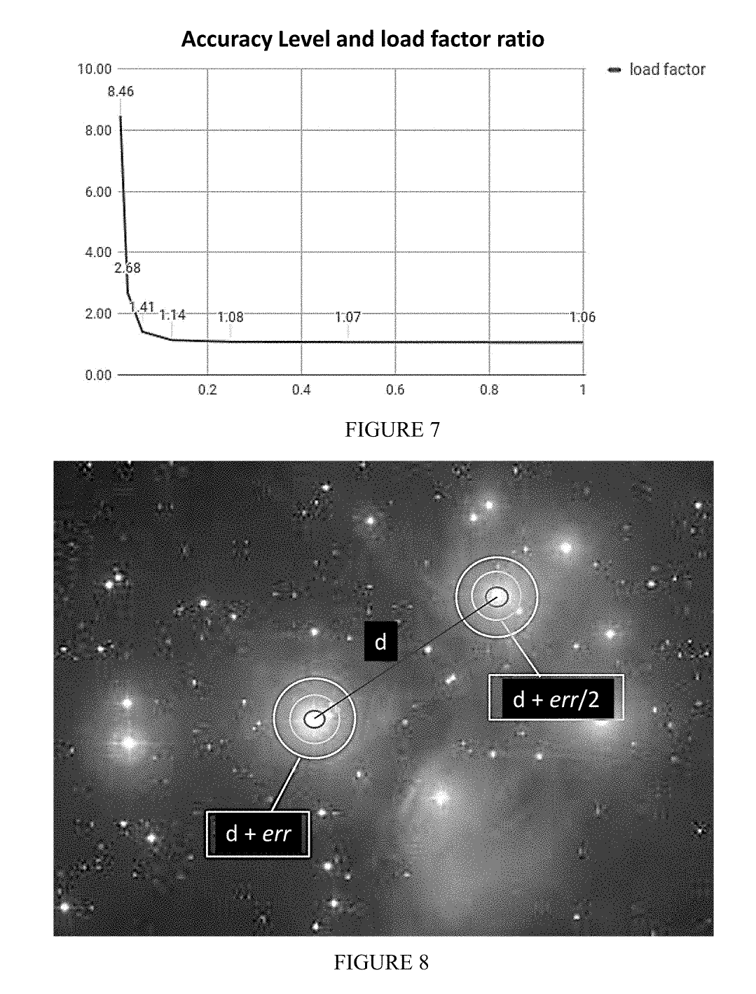

Reference is now made to FIG. 7, which shows a graph of AL and load factor ratio for a mobile star tracking. Accuracy level and star detection ratio are shown in the graph, where the x-axis represents the AL values on a logarithmic scale, and the y-axis represents the ratio between all keys in the database and the candidate load factor patterns.

Reference is now made to FIG. 8, which shows a graphic representation of Gauss's distribution of standard distance deviation error (err) around the stars.

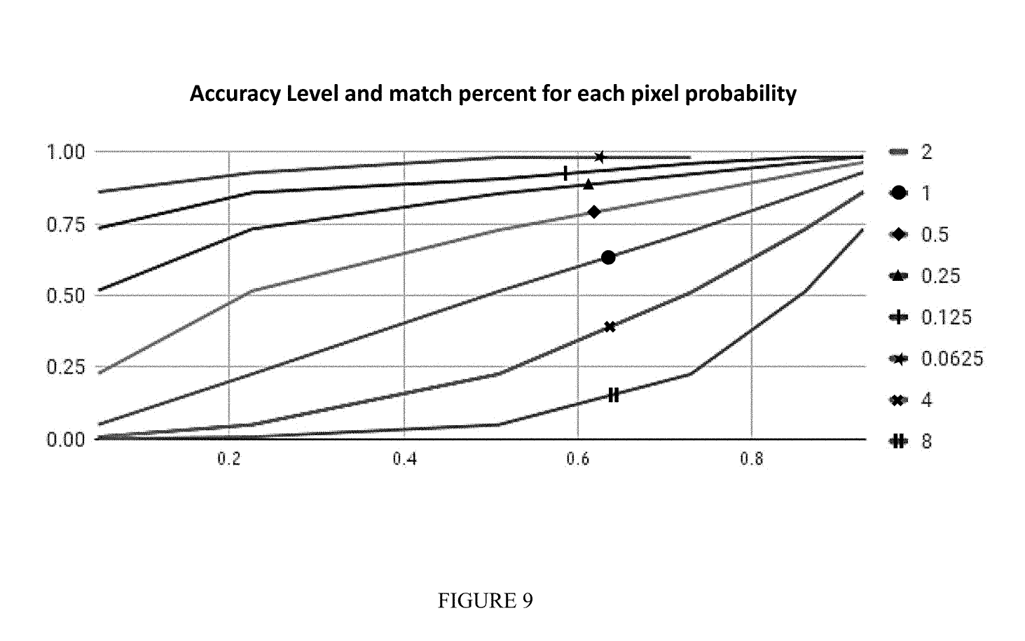

Reference is now made to FIG. 9, which shows a graph of the AL and distribution effect on right matching probability. The lines represent different AL values in logarithmic scale. The y-axis represents the probabilistic error added to each distance, and the x-axis represents the probability to retrieve star triplets from the YBS with that error.

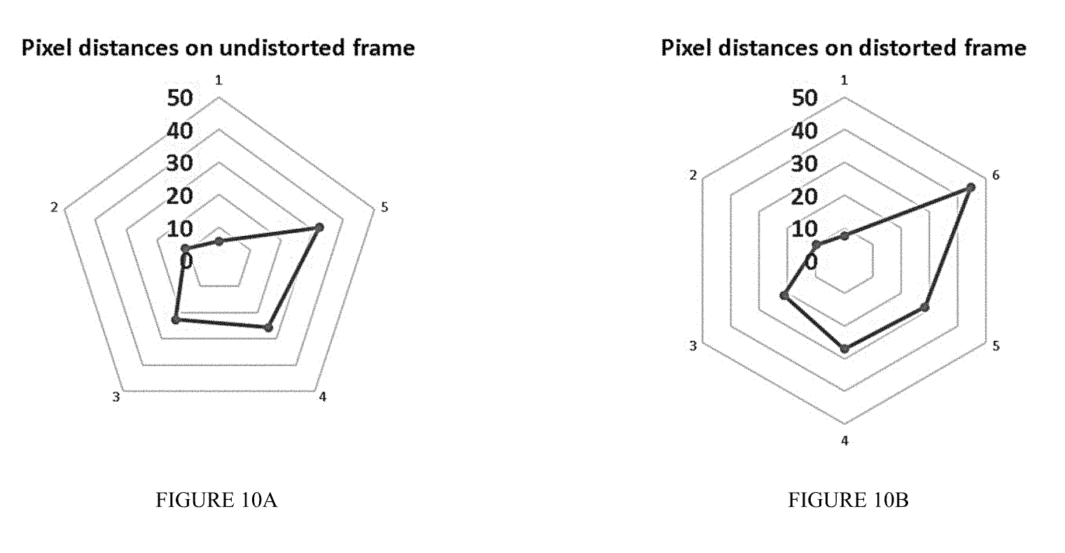

Reference is now made to FIGS. 10A-10B, which show pixel distance deviations on undistorted frame (FIG. 10A) and distorted frame (FIG. 10B). Each pentagon in the graph represents a 10-pixel deviation from the real distance in the frame.

Reference is now made to FIG. 11, which shows a visual explanation for the confidence calculation process. It shows the calculation of the match confidence for triplets with several keys.

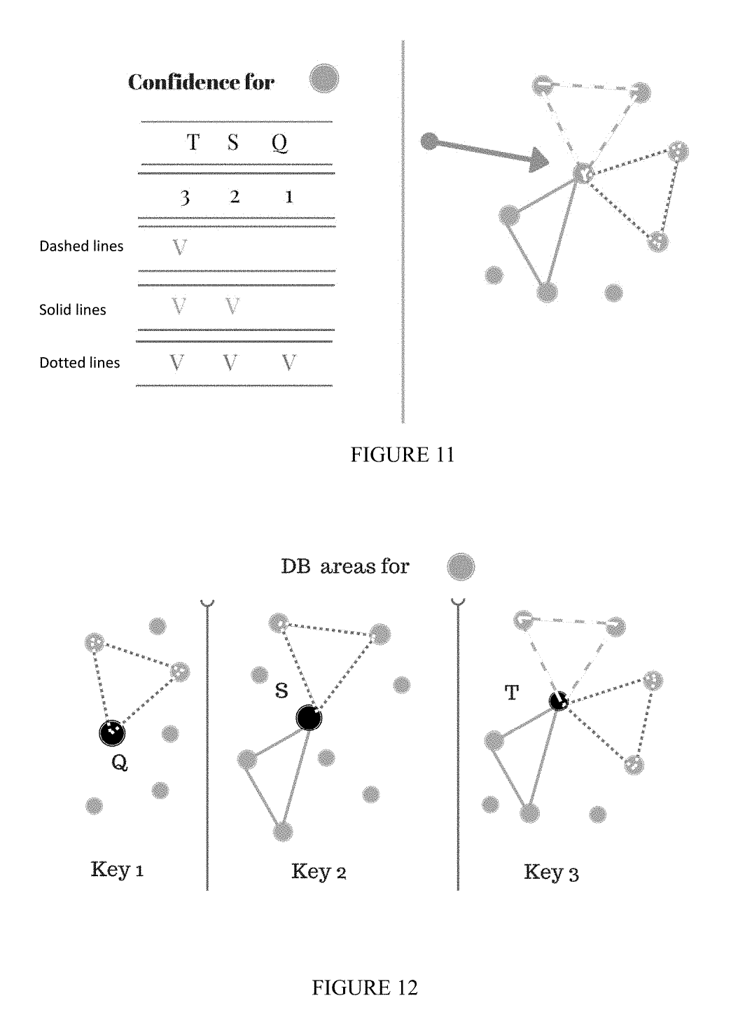

Reference is now made to FIG. 12, which shows a star's possible location in the catalog according to its closest stars.

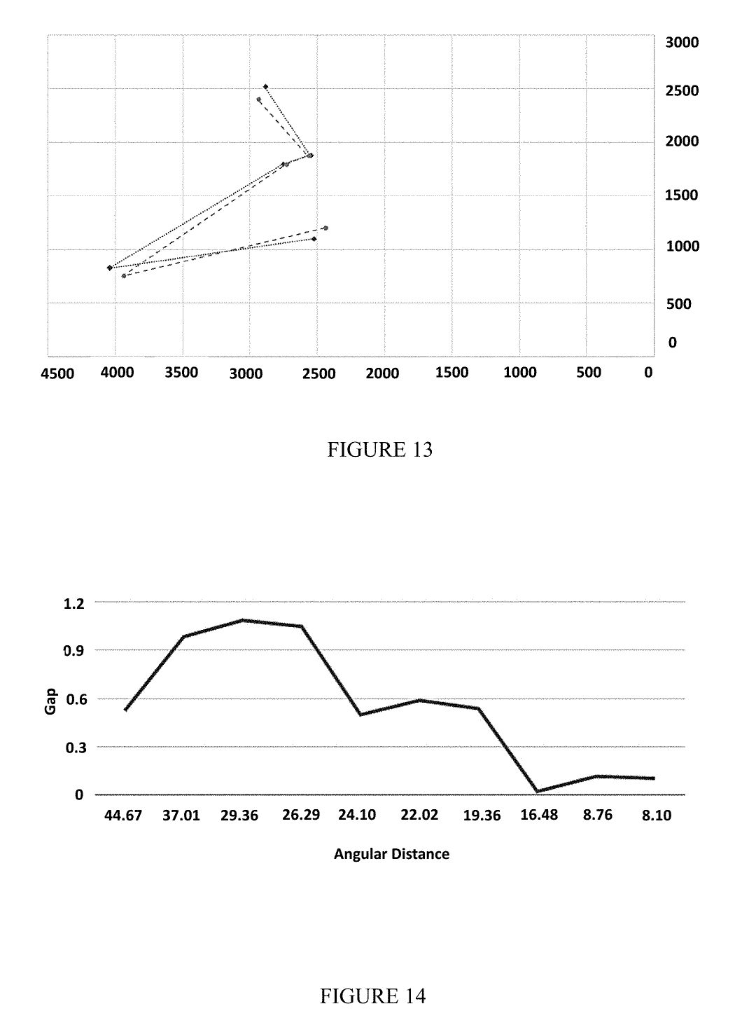

Reference is now made to FIG. 13, which shows two frames of the Orion constellation from different locations.

Reference is now made to FIG. 14, which shows a graph of the angular distance gap between two stars. It shows that the larger the distance between the stars (in two frames), the larger the gap can be.

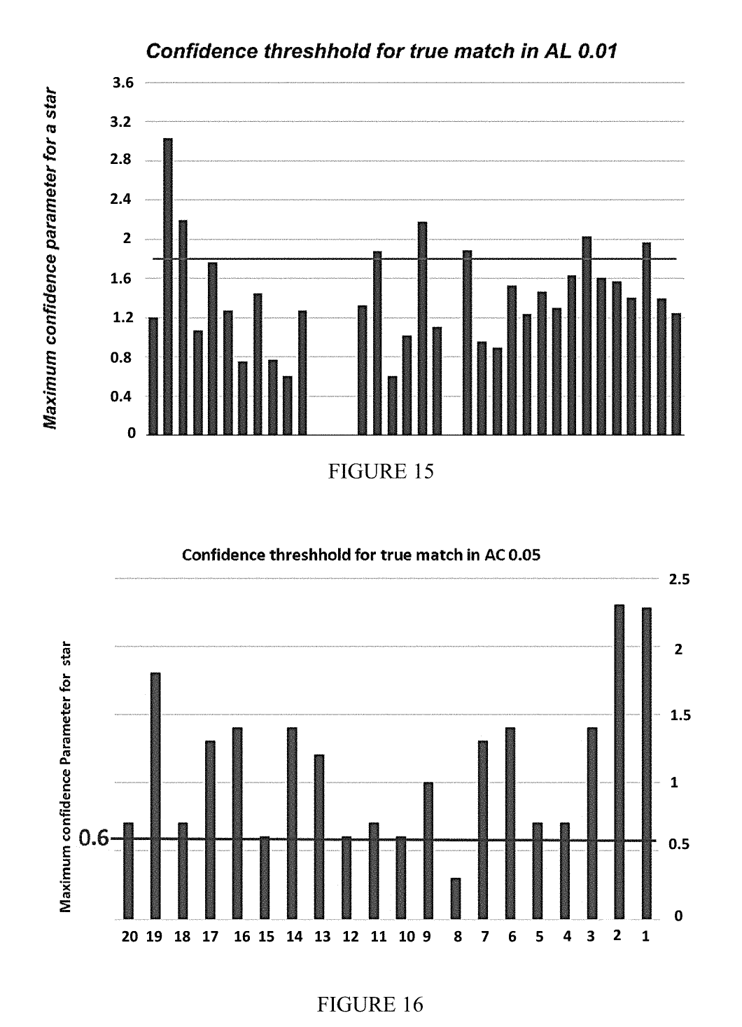

Reference is now made to FIG. 15, which shows a graph of the confidence threshold for true match in AL 0.01.

Reference is now made to FIG. 16, which shows a graph of the confidence threshold for true match in AL 0.05.

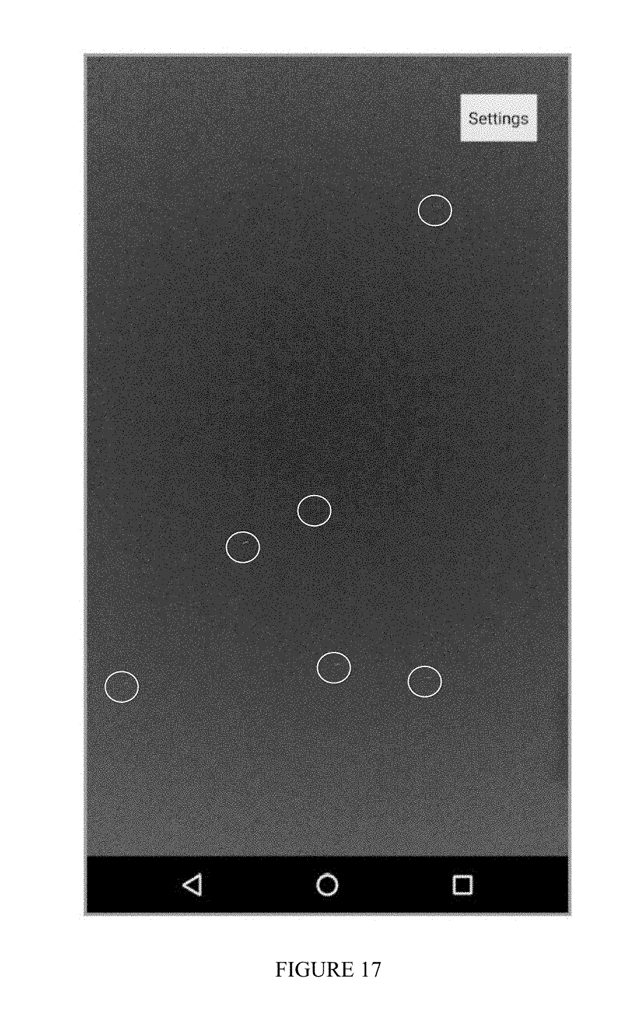

Reference is now made to FIG. 17, which shows a screenshot of a Nexus 5x android device with star-detection application. The stars are surrounded by white circles (“Big Bear” constellation). The stars were detected in real time (5-10 Hz) in 1080p (FHD) video resolution. This image contains significant light pollution at the lower side of the image.

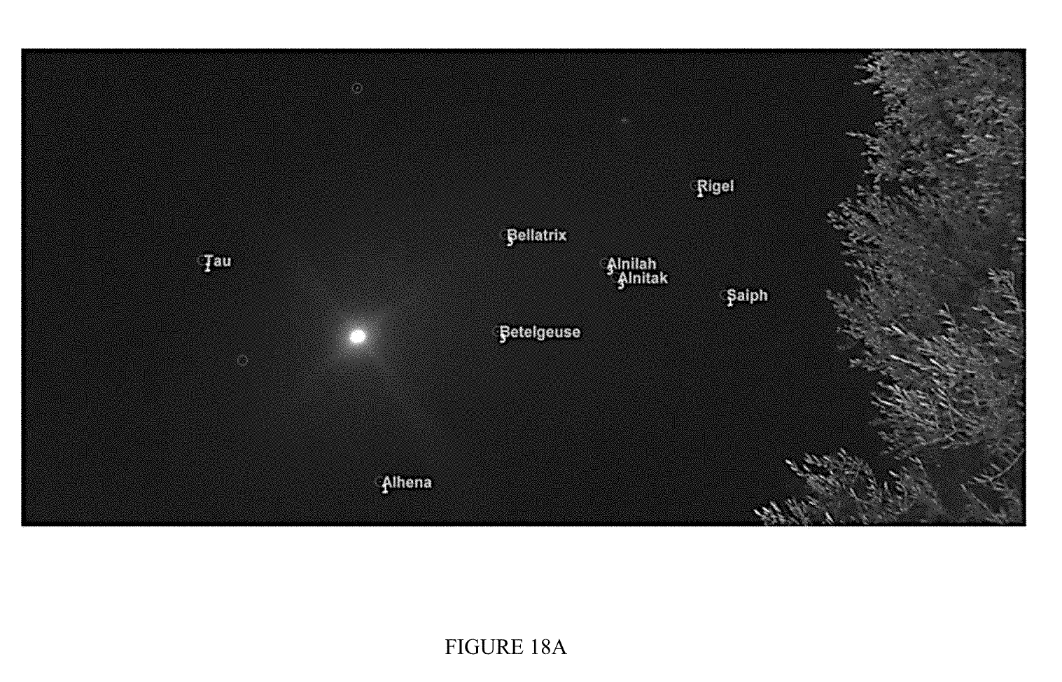

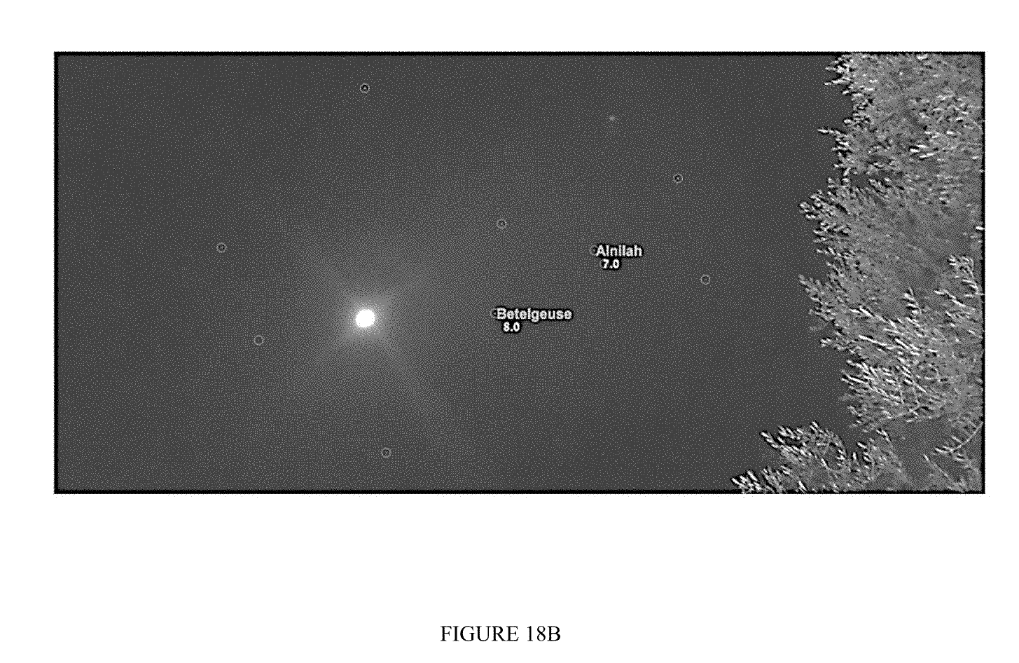

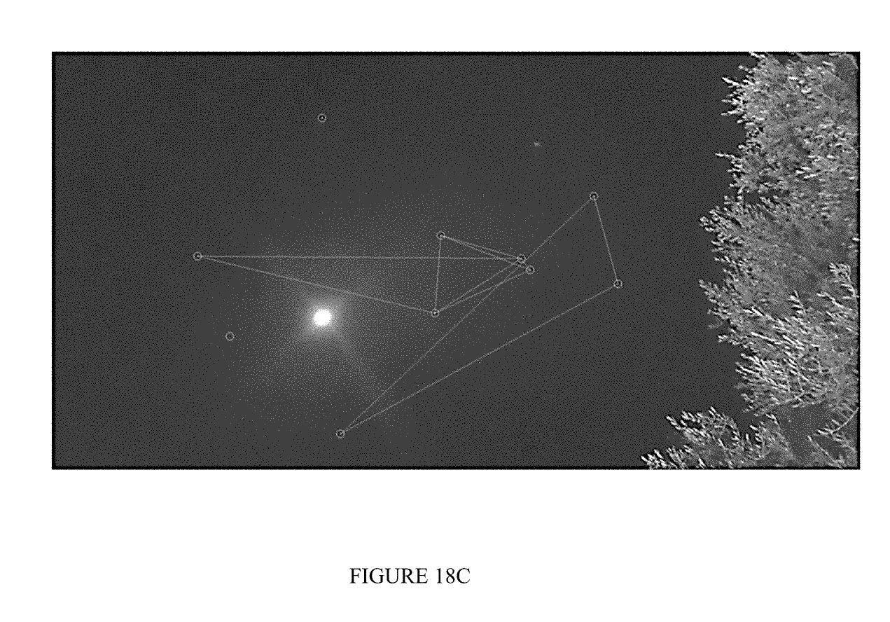

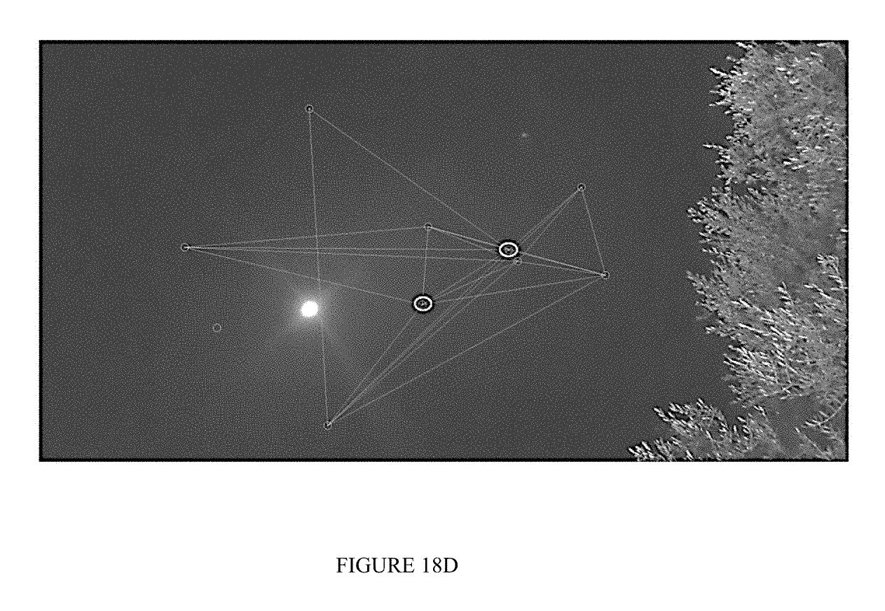

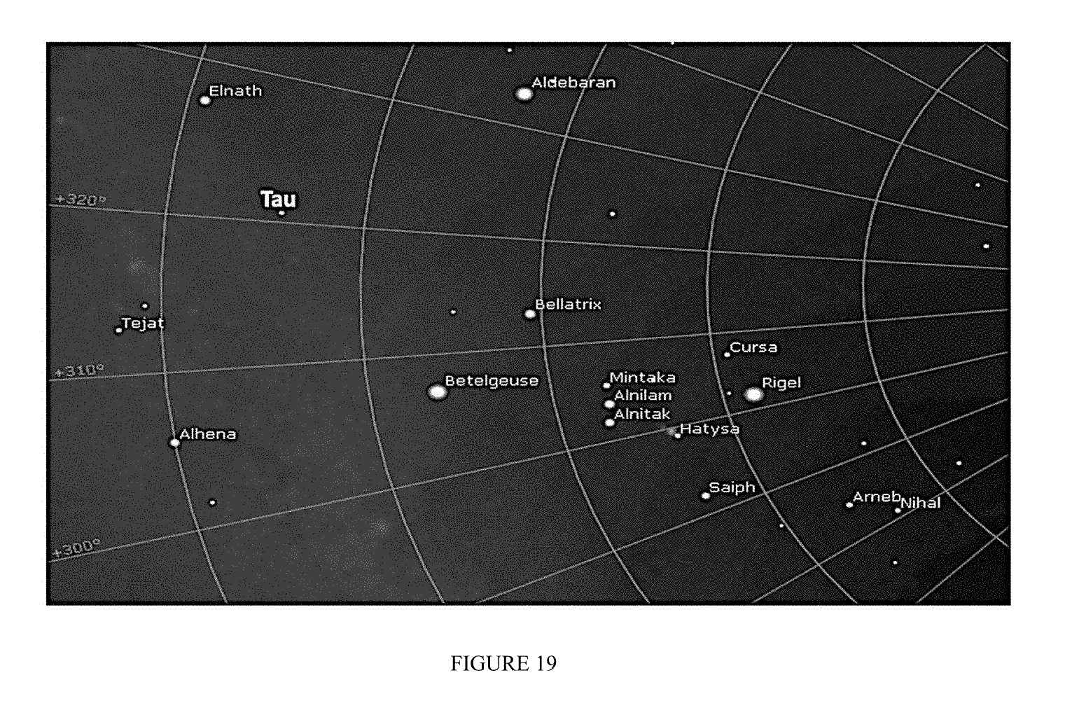

Reference is now made to FIGS. 18A-18D, which show images recorded with star-detection application capture by a Samsung Galaxy S6 android device. FIG. 18A and FIG. 18B, represent star frames with their correct identification and match grade (confidence). FIG. 18C and FIG. 18D, represent the triangles pulled from the hash table using the Star Pattern Hash Table (SPHT) algorithm. The algorithm was set to different AL each time. FIG. 18B and FIG. 18D represent the algorithm results when AL was set to higher numbers. FIG. 18A and FIG. 18D represent the algorithm when AL was set to lower numbers.

Reference is now made to FIG. 19, which shows an image of the Orion constellation as it appears in the Yale Bright Stars Catalog (YBS). This catalog visualization was done via the Stellarium system.

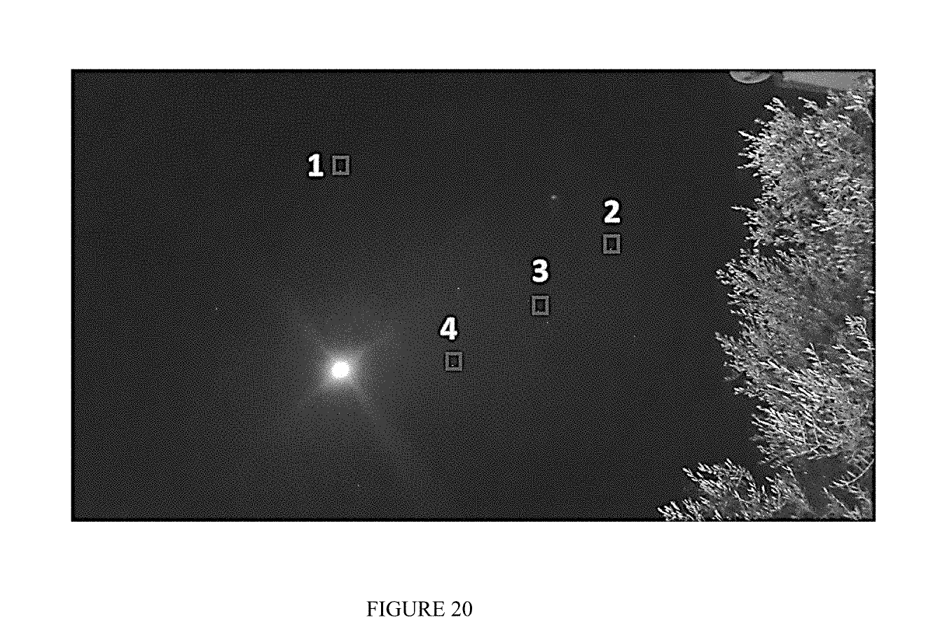

Reference is now made to FIG. 20, which shows an image recorded with star-detection application capture by a Samsung Galaxy S9 device. The figure shows the Star Pixels excepted inaccuracy.

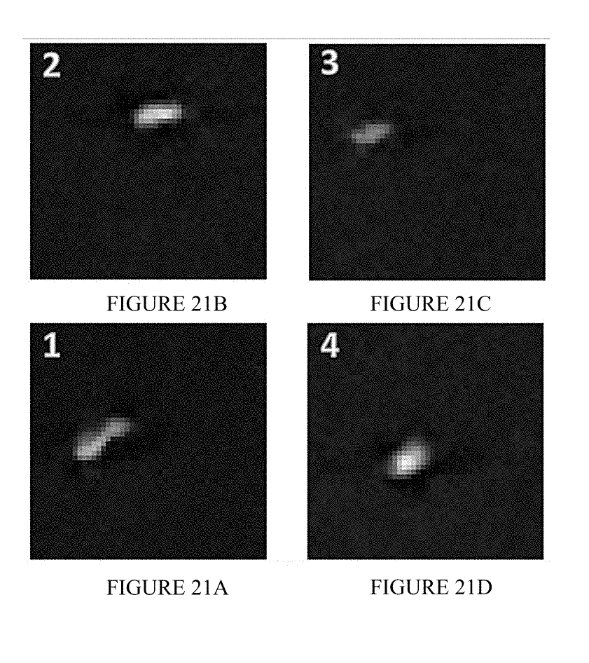

Reference is now made to FIGS. 21A-21D, which show four enlarged frames of the image of FIG. 20. Each of the rectangles size is 50×50 pixels and in it are examples for star appearance on the frame.

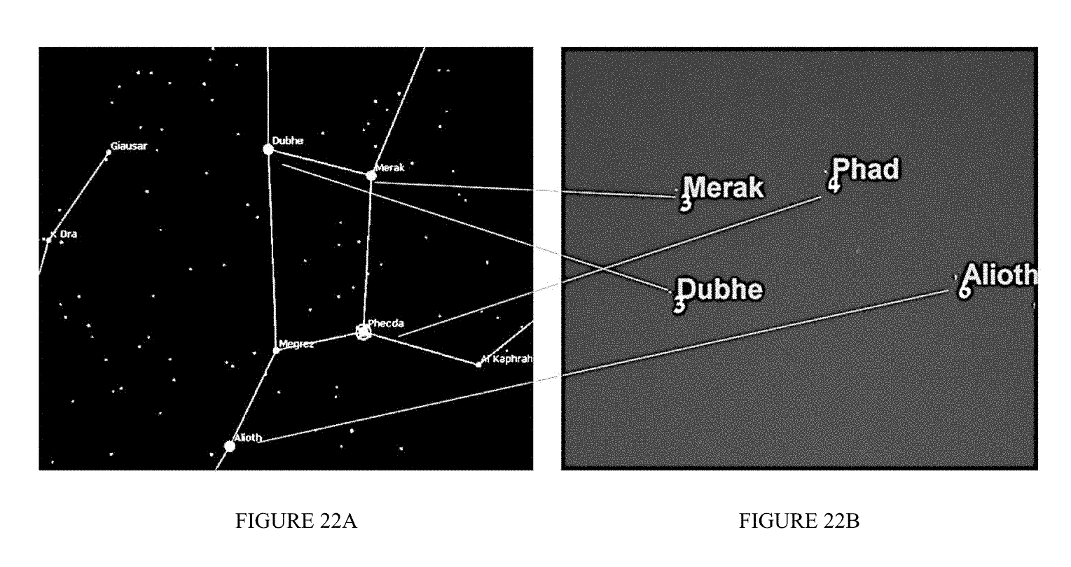

Reference is now made to FIGS. 22A-22B, which show the star-tracker algorithm implementation on Samsung Galaxy S9 device. FIG. 22A shows a frame of the big bear constellation with star identification. FIG. 22B shows the DB simulation of the big bear constellation as presented in Stellarium tool.

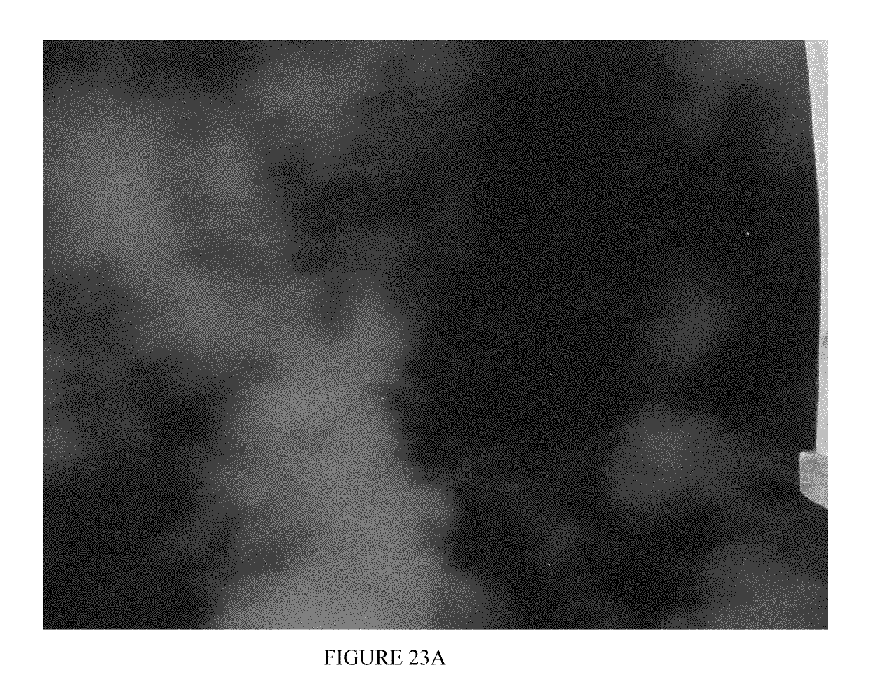

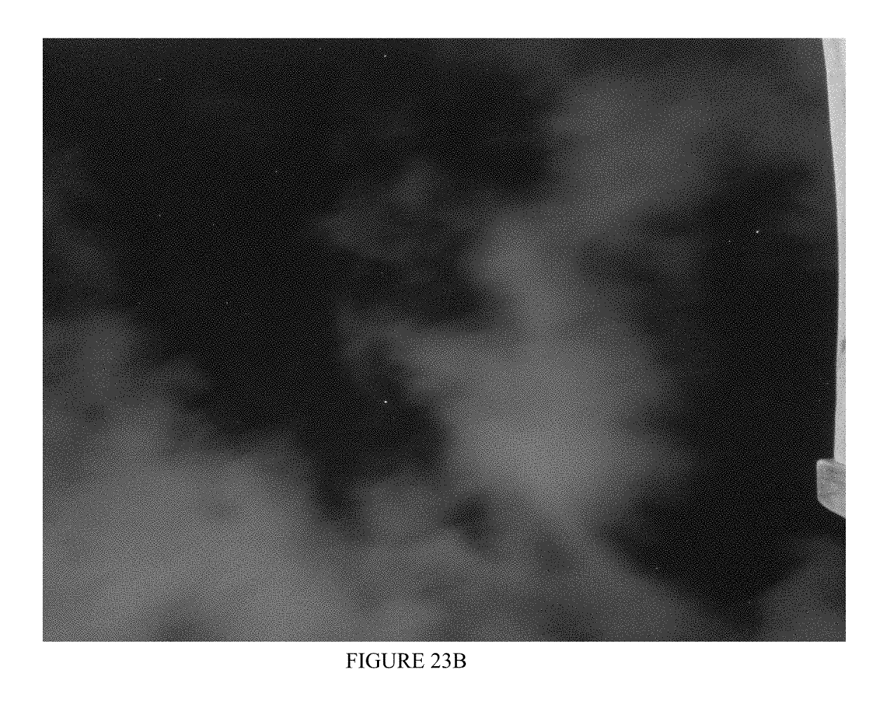

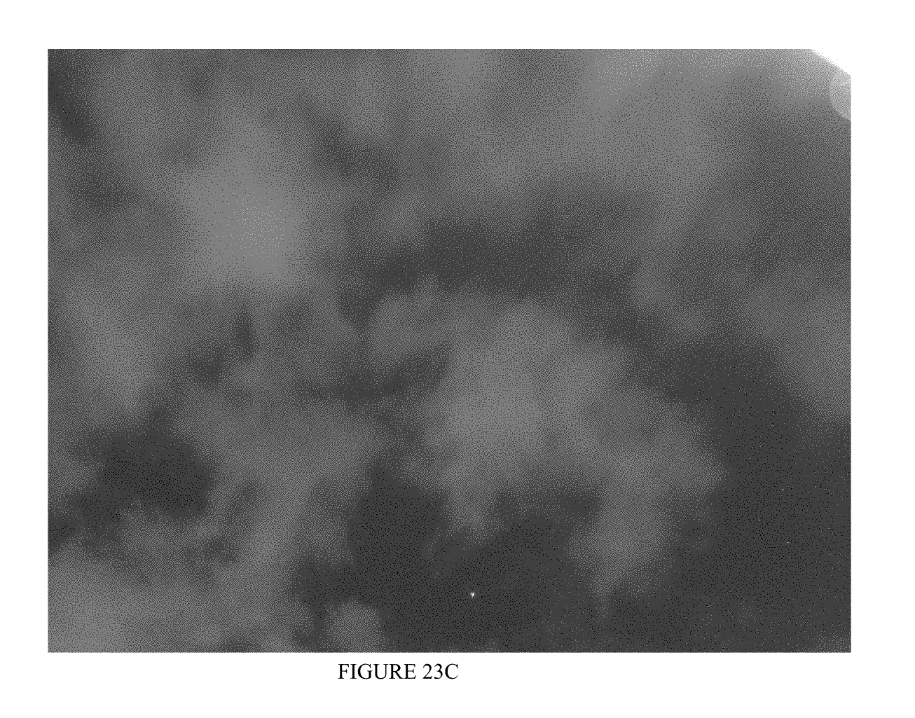

Reference is now made to FIGS. 23A-23C which show images captured with a Raspberry Pi, with a standard RP v2.0 camera.

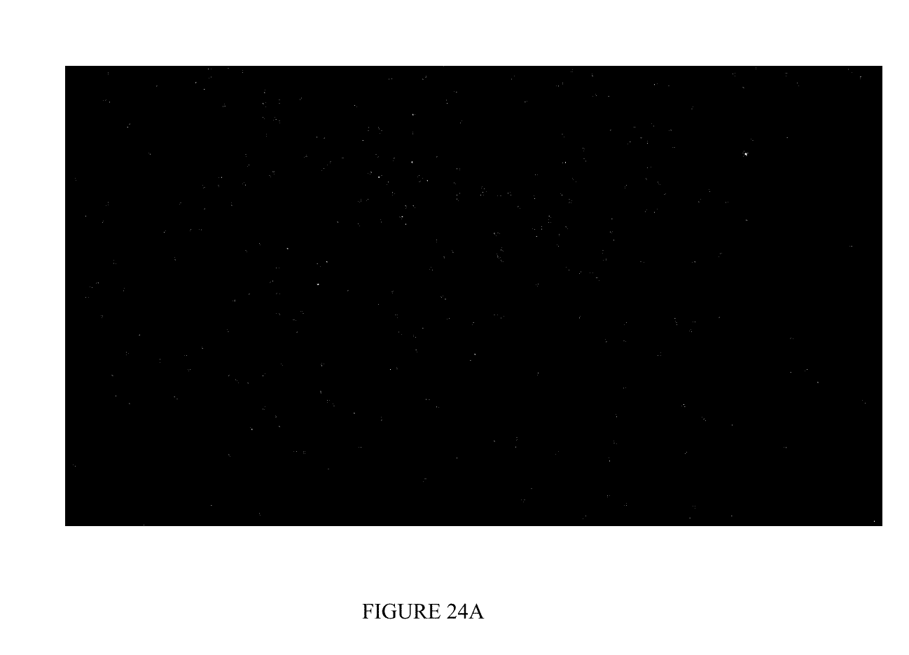

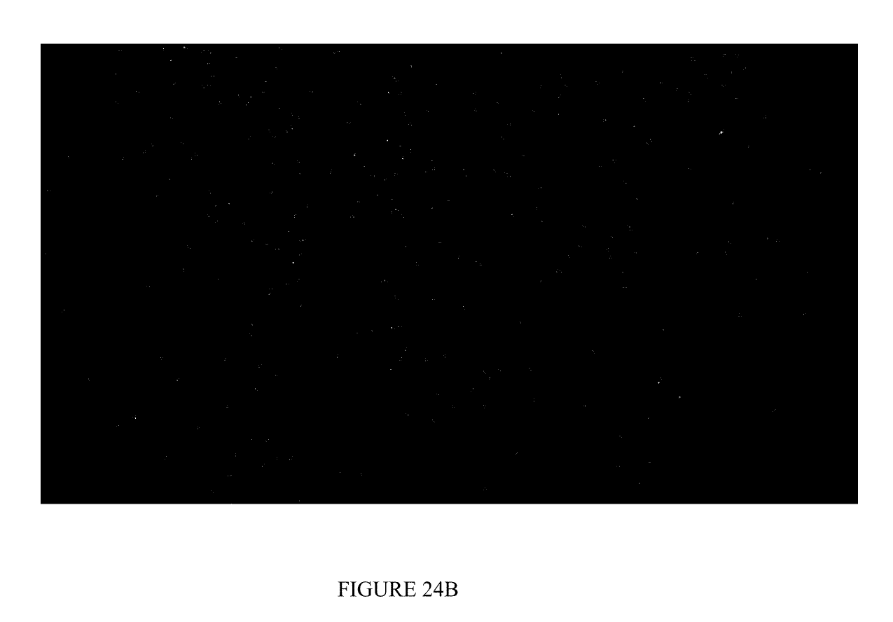

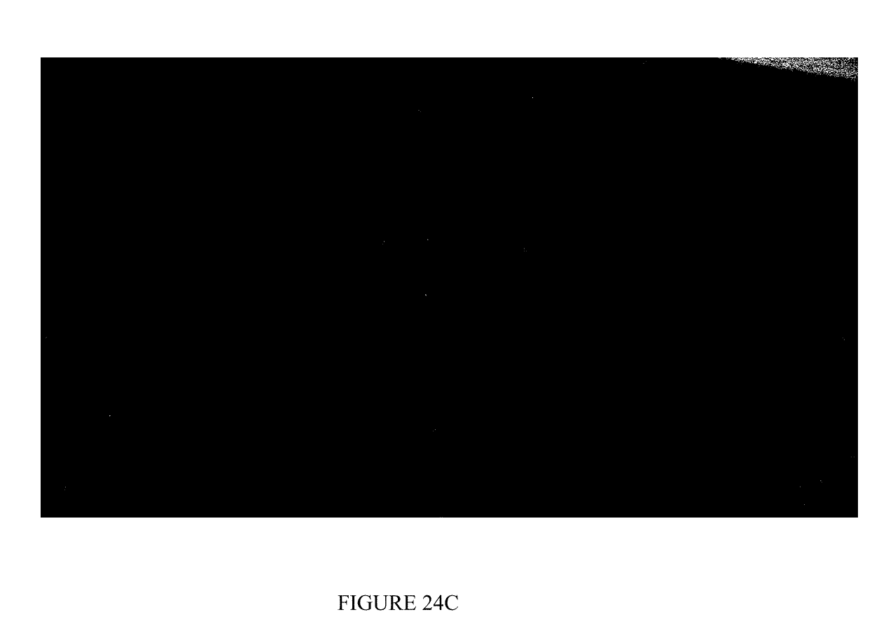

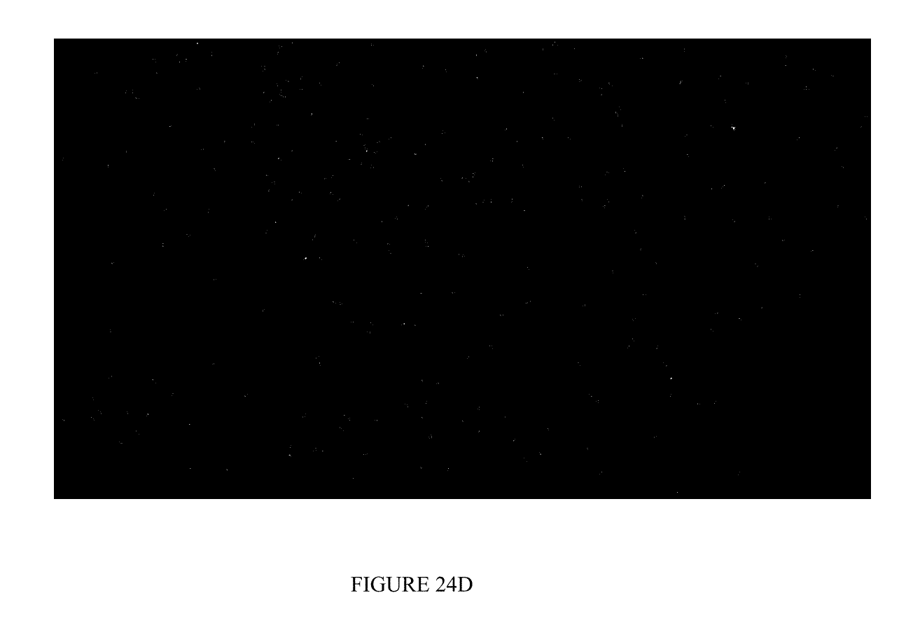

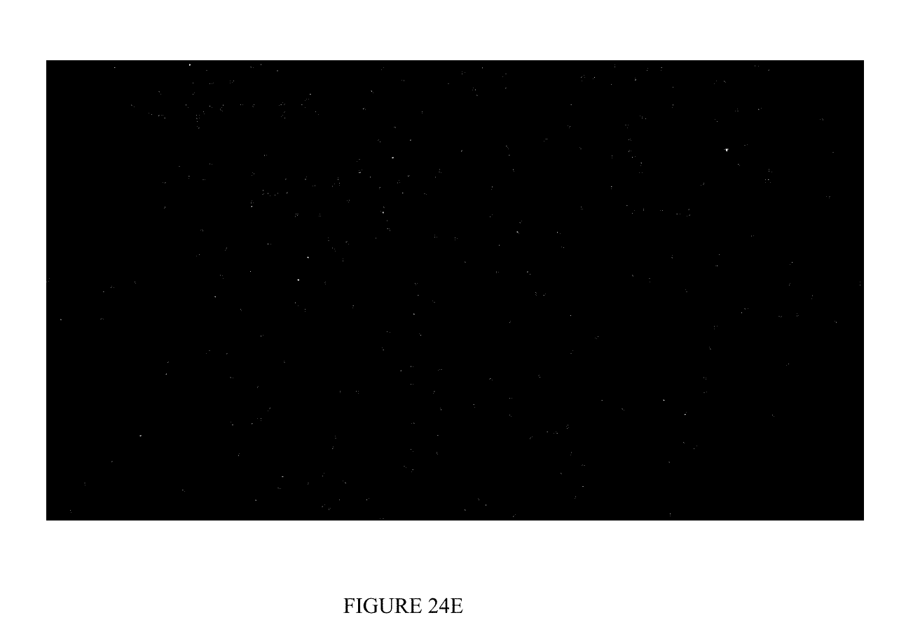

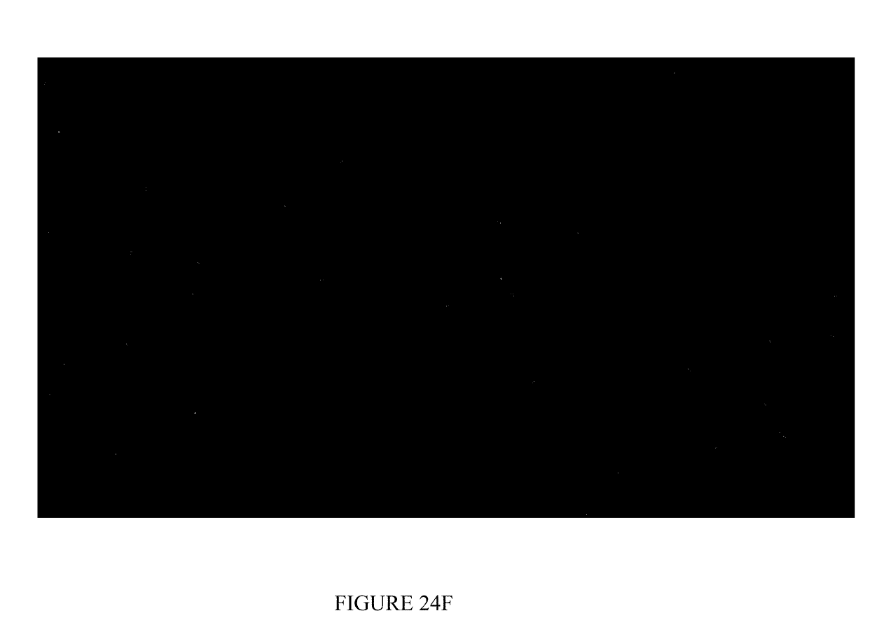

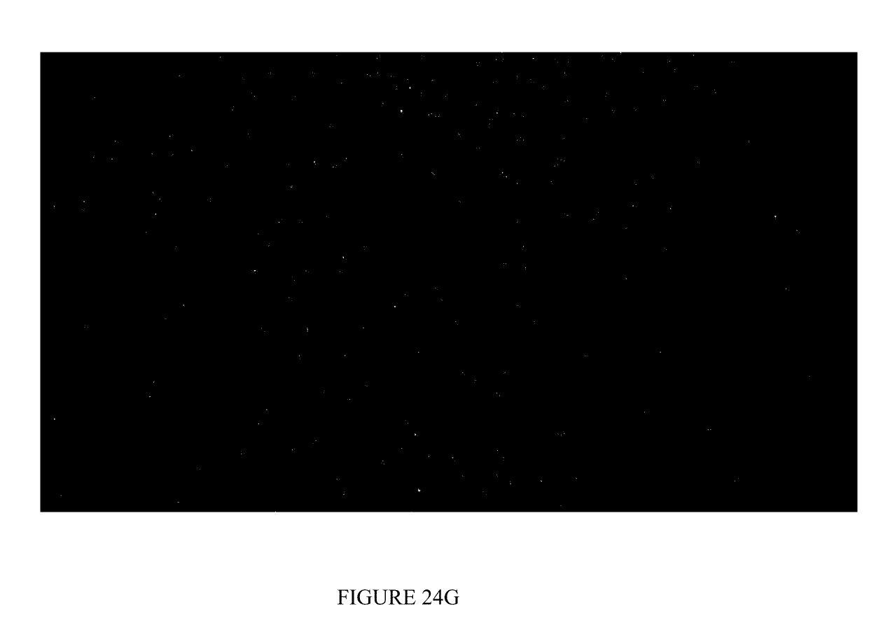

Reference is now made to FIGS. 24A-24G show images captured with a star tracking device.

Many benefits and applications may result from the disclosed embodiments. Knowing a vehicle's exact orientation is a condition for many applications, including autonomous driving. While global navigation satellite system (GNSS) receivers may report orientation, they suffer from inherent accuracy errors, especially in urban regions, areas without communication to satellites (tunnels, underground, polar regions, and/or the like. In some circumstances star tracking may produce orientation accuracy better than GNSS. A system for star tracking may improve laser aiming, antenna aiming, camera aiming, position computation, and/or the like, especially when GNSS are unavailable.

The star tracking embodiments of the present application may effectively handle outliers such as: optical distortion created by atmosphere condition, partial non-line-of-sight, star-like lights (e.g., airplanes and antennas), and/or the like. The disclosed technique may handle a wide range of star patterns and has a low computational load which may by applicable for low-end mobile embedded platforms with limited computing power (e.g., mobile phones). The technique is suitable for both space (i.e. nanosatellite) and ground (i.e. vehicle, UAVs, etc.) applications.

As stated above, a star tracking process may identify the stars on a given image. Identifying means to find the optimal matching (or registration) between each image-star and its corresponding star in the database. Finding a star registration may be formalized as following:

The angular distance between two stars as observed from earth—may be addressed as fixed. Therefore, a fixed angular star database may be used.

The image frame may contain outliers and some of the stars may be eliminated (Type I/II errors) using a validation process.

The registration process has two major modes:

“lost in space”: where the orientation is computed in a stateless-manner (i.e, regardless of the previous computed orientations).

Continuous: where the last computed orientation is part of the current input.

a. Naturally, (i) may take more time than (ii) as the searching space is larger.

Given three star pair registrations, the image orientation is well defined. In fact, even two star registrations might be sufficient for computing the image orientation. However, nn injective orientation values cannot be achieved using a single star identification since the result has a rotational degree of freedom. Three star pair registrations were found to reduce the number of false registrations. For example, at least three light sources in the image can identify a triangle with associated lengths and angles. For example, the lengths and angles of the triangle are computed and compared with computed lengths and angles of light sources from a database.

Given an image-frame F and its global orientation T, the validity of T with respect to F may be computed as following: for each star in the image (s ∈ F) compute the global orientation of s denoted as Tₛ, and for each Tₛ compute the distance between s and the closest star in the database. The overall weighted sum (e.g., RMS) of these distances can be treated as the quality of the global orientation T with respect to F and the star database. A ybs, such as the Yale Bright Star Catalog (YBS), may be used to identify light sources detected in the image frame F. Every star s ∈ YBS may have the following attributes: name, magnitude and polar orientation. A camera image frame F may denote a 2D pixel matrix from which a set of observed stars can be computed. Each frame-star p ∈ F may have the following attributes: 2D coordinates, intensity and radius.

Current tools for celestial navigation are designed for satellites using dedicated high quality cameras, and therefore may ignore atmospheric effects, such as noisy images, geometric aberrations, spherical aberrations, and/or the like. Embodiments described herein solve the technical problem of handling relatively large errors (in some cases ˜2 degrees error—due to atmosphere aberrations) and therefore is suitable for robust ground and/or areal applications. These solutions may handle large angular inaccuracy, and allows applying the techniques on low-quality cameras and/or lens (e.g., smart phone cameras, wide angle lenses, etc.) in real time. Other applications include nano/pico satellites using low-quality (smart phone like) cameras, and air/ground/sea applications where atmospheric errors may be significant.

Following is pseudocode for a naïve algorithm for star tracking.

```
  ALGORITHM 1: Naïve
  Input: Frame (F) and star Database (YBS)
  Result: A matching between a set of pixels pᵢ ϵ F and stars sᵢ ϵ YBS
Pick a triplet of stars < p₁, p₂, p₃ > ϵ F;
Set < dₚ₁, dₚ₂, dₚ₃ > = sorted set of distances between every two stars from the triplet;
For every 3 stars < _{S1}, _{S2}, _{S3} > ϵ YBS do
< dₛ₁, dₛ₂, dₛ₃ > = sorted set of distances between every two stars from the
triplet;
$Compute {G}_{i} = {\sum }_{i = 1}^{3} \sqrt{\frac{{( {d}_{pi} - {d}_{sj} )}^{2}}{3}}$
End
Return < _{S1}, _{S2}, _{S3} > with minimum Gᵢ
```

The algorithm's complexity is O(N₃), with |N| being the size of YBS which is ≈10,000. Therefore, this algorithm may not by efficient. Furthermore, this algorithm may not handle outliers which are very common in earth located star tracking images.

The improved algorithm suggested here can handle both accuracy and runtime issues by using Hash map with star patterns as keys and consider the stars' intensity as another factor to increase the accuracy. In order to minimize the search time on the DB while improving the efficiency, we use the geometric hashing preprocessing technique.

A starset is defined as a set of stars in the database, denoted <s₁, s₂, . . . , sₖ>∈ YBS. A key function of a starset may be defined as:

key(<s₁, . . . , sₖ>)=sort(∪_{i,j=1}^{k}Round(distance(sᵢ−sⱼ)))

A value function of a starset may be defined as:

value(<s₁, . . . , sₖ>)=∪ᵢ₌₁^{k}sᵢ·name

A Star Pattern Hash Table (SPHT) may be defined as SPHT=∪ of all Starsets (such as of size k) in YBS which may be detected by the star-tracker camera and their distances from each other are less than the camera aperture with magnitude less than a value, such as 5.

Following is pseudocode of an improved algorithm for star tracking.

ALGORITHM 2: Improved

```
    Input: Frame (F ) and star Database (YBS)
    Result: A matching between a set of pixels pᵢ ∈ F to stars sᵢ ∈ YBS
pick a set of stars: < p₁ , ..., pₙ > ∈ F.
Set k = key < p₁ , ...pₙ >
v[ ] =get values from SPHT where key is denoted k
if v is empty then pick another set
else
    for each value in v do
        for every pixel NP in Frame < p₁ , ..., pₙ > do
            kᵢ = key < p₁ , ..., pₙ − 1, NP >;
            get values from SPHT where key is:
            kᵢ to NV;
            if NV is empty then
                set gradeᵢ to 0
            else pick another starset
        end
    end
end
return < p₁ , ..., pᵢ > with < s1 , ... , sₙ >
```

Optionally, a hashing process may precompute star triplets (with their respective angles). For efficiency, this may be done by dividing the sky with a virtual grid and for each cell in the grid, compute all the visible star triples. The robustness of the method may be to use overlay cells in the computation. The hashing algorithm only runs once to add the computed parameters to the system DB, thus, the O(N³) hashing complexity does not affect the complexity which, like in many hash maps, has O(1).

The improved algorithm uses a preprocessing stage which stores a large number of starsets (star patterns) into a hash table data structures—using an angular geometric hashing function. The accuracy value was measured by the following modified RMS equation:

$$RMS = \sqrt{\frac{{\sum }_{i = 1}^{n} {dist ( {s}_{i} , {p}_{i} )}^{2}}{n}}$$

Following are experimental results of some embodiments. A framework that simulates night sky images may be used to test performance and accuracy. A Stellarium tool may create an image of the sky as they are expected to be seen from a given location and time (using the HYG database). The Stellarium tool was adjusted to show relatively bright stars (with magnitude less than 5). To extract the pixel-coordinates from each image, we have used the Python image processing toolkit. The algorithm was tested on three types of images: (i) Synthetic accurate: images with no errors. (ii) Inaccurate: images of real stars with some controlled inaccuracy in the star-coordinates. (iii) Outliers: images with additional random outliers stars and missing stars (Type I/II errors). The geometric hashing was constructed using star-triplets (triangles) as patterns.

The angular distance between two stars as observed from a star tracker device may be approximated as the L₂ distance between the stars in the image. The approximation may be inaccurate due to the following factors: (i) limited camera resolution, and (ii) the existence of outliers in the image.

In order to be able to find star patterns in the DB despite the inaccuracies mentioned above, we decreased the level of accuracy in our calculation when pre-computing the star pattern DB. In this experiment, we determine the accuracy by counting the decimal places of every distance (e.g., accuracy level may be two decimal places). Decreasing the accuracy level may help find more star patterns that resemble the patterns on the image frame. However, decreasing the accuracy level may also find too many star patterns and increase the system runtime.

The average running time in case of identifying clean stars in a synthetic image was ≈1.2 milliseconds per image.

In order to test the accuracy level needed to detect as many patterns as possible using the geometric hashing technique (without outliers), many values where tested for each key under different accuracy levels. We used a YBS DB to create the geometric hashing table. The graph depicted in FIG. 6 represents the probability to find a star pattern of size N corresponding to accuracy level a. For example, even for accuracy level of 1, the load factor is ≈1.23 (1/0.81). The results show that accuracy level in FIG. 6 gives a unique detection for each pattern. The tradeoff may be the higher the accuracy, the greater the chance for missing similar patterns in the image frame. In order to test the deviation in distance calculation, we used the simulator to create images and modified the images by moving and adding pixels.

FIG. 6 shows the distance deviation allowed in order to detect a pattern with a given accuracy value. The experimental results show that the distance accuracy needs to be approximately 10% of the accuracy value.

The accuracy value highly effects the experiment results and should be adjusted in relation to the environment conditions. The experiment shows that the best accuracy value should be between 1 and 2. Other parameters such as camera resolution, atmospheric condition and FPS may be considered when adjusting the accuracy value. Optionally, several geometric hashing tables (preprocessing phase) are computed for different accuracy values.

A benefit of embodiments may be being able to cope with several kinds of outliers. The low processing time geometric hashing process makes the algorithm suited for embedded low-cost devices. A smartphone camera may capture the night sky with relatively good resolution.

Following is pseudocode of a brute force algorithm for star tracking.

ALGORITHM 3: Brute Force (BF) Algorithm

```
    Input: Frame (F) and star Database (YBS)
    Result: A matching between a set of star-pixels pᵢ ∈ F and stars
sᵢ ∈ YBS pick a triplet of stars < p1; p2; p3 > ∈ F
let < dp1; dp2; dp3 > be a sorted set of distances between each two stars
from a star-pixels triplet < p1; p2; p3 > ∈ F
let < dsi; dsj ; dst > be a sorted set of distances between each two stars
from a star-catalog triplet < si; sj ; st > ∈ YBS
for every 3 stars < si; sj ; st > ∈ YBS do
    create < dsi; dsj ; dst >
end
return < si; sj ; st > with minimum RMS as calculated by equation 1.
```

The algorithm was developed under the following observations:

Registration is the process of identifying pixels in the image as real stars. Full registration cannot be accomplished without identifying exactly two stars. When three or more stars are identified, the system becomes over-determined and a modified RMS equation 1 may be used:

$$RMS = \sqrt{\frac{{\sum }_{i = 1}^{n} {( dist ( {s}_{i , j} ) - dist ( {p}_{i , j} ) )}^{2}}{n}} \qquad ( 1 )$$

where dist(s_{i,j}) is the angular distance between two stars (i,j) in the database as described elsewhere herein and dist(p_{i,j}) is the Euclidean distance between two stars (i, j) in the frame (pixels).

Although identification of two stars is sufficient for full registration, the proposed algorithm seeks to match star triplets due to the relatively large number of outliers.

The angular distance between two stars as observed from earth may be addressed as fixed. Therefore, a fixed angular star database may be used.

A camera image frame F may denote a 2D pixel matrix from which a set of observed stars can be computed. Each frame star p ∈ F may have the following attributes: 2D coordinates, intensity and radius.

A star database such as the Yale Bright Stars Catalog (YBS) may be used. Every star s ∈ YBS may have the following attributes: name, magnitude and polar orientation.

Angular Distance between two stars is the distance between two stars as seen from earth. Each star in the YBS has the spherical coordinates: right acceleration and declination. The angular separation between two stars s₁, s₂ may be computed using the formula (2):

AD(s₁,s₂)=sin(dec₁)sin(dec₂)+cos(dec₁)cos(dec₂)cos(RA₁−RA₂) (2)

The angular distance units are degrees.

Star Pixel Distance is the distance between two stars in the frame. The stars in the frame are represented by x, y coordinates (pixels), the distance may be computed using the formula (2). The star pixel distance unit is pixels.

Distance Matching is a transformation formula T(p)=s, p ∈ F, s ∈ YBS that may allow to match the frame stars' distance (pixels) to the angular distance (angles). For two catalog stars s₁, s₂ and camera scaling: S the stars' pixel distance may be:

StarPixelDistance(p₁,p₂)=S*AD(p₁,p₂)

Given an image F as set of pixels <p₁, . . . , pₙ>∈ F and a stars database YBS. A star label may be set according to its matching star s in the YBS. We define for each star pixel p ∈ F: A label L(p) that is its matching stars s ∈ SC. If a match was not found the star pixel F will be label (false).

The brute force (BF) algorithm seeks to find a match between the stars captured in each frame and the a priori star database. A common practice is to take three stars from the frame and match this triplet to the stars catalog. Algorithm 3 describes this naïve method.

After labeling each star in the frame, the orientation may be calculated in the following manner: Given a match: S:=<s₁, . . . sₙ>∈ YBS with P:=<p₁, . . . pₙ>∈ F the algorithm will return a matrix O_{[1,3]} and a vector T₂ so that S=O×M×P with M being the rotation matrix in order 3 and T being the translation vector (from pixel (0,0)). This matrix defines the device orientation.

Given an image frame F and its global orientation T, the validity of T with respect to F may be computed as following: for each star in the image (s ∈ F) compute the global orientation of s denoted as Tₛ and for each Tₛ compute the distance between s and the closest star in the database. The overall weighted sum (e.g., RMS) of these distances can be treated as the quality of the global orientation T with respect to F and the star database.

The algorithm's complexity is O(N³), with |N| being the size of the star database, which is ≈10,000. Preprocessing Algorithm: SPHT

To avoid a massive amount of searches (brute force), the algorithm may use hash map techniques that, when one fabricates its own database, has a runtime search complexity of O(1). The algorithm computes each star's triangle distances in the database and saves each triangle as a unique key in this table. The value of each key will be the names of the stars as they appear in the YBS.

The hashing process goal is to a priori construct interesting star triplets (with their respective angles). For efficiency considerations, this is done by dividing the sky with a virtual grid. From this, one can compute all the visible star triplets. A key factor in the robustness of the method is to utilize overlay cells in the computation. The hashing algorithm runs only once to create the system database. Thus, the O(N³) hashing complexity does not affect the general algorithm complexity, which, like any hash map, has O(1). Each star triplet creates a unique set of three angular distances. For each triplet of stars in the catalog, we save a vector of catalog star numbers as the key and a vector of sorted angular distances between the stars as the value (the triangle implementation can be extended to n patterns of stars). We define:

Starset: a set of three stars in the catalog, denoted as <s₁, s₂, s₃>∈ YBS.

Key function of a starset: key(<s₁,s₂,s₃>)=sort(∪_{i,j=1}³ Round(distance((sᵢ−sⱼ))))

Value function of a starset: value(<s₁,s₂,s₃>)=∪ᵢ₌₁³ sᵢ·name

SPHT: SPHT=∪ all Starsets in YBS that might be detected by the star tracker camera and their distances from each other are less than the camera aperture with magnitude less than a value, such as 5.

### Measurement Error and Accuracy Figure

Because measurement errors exist (due to lens distortions, etc.), it is difficult to match computed triangles to a priory known triangles in the database. Therefore, a rounding method may be applied. Seemingly, a naive rounding would be sufficient. However, the inaccuracies (distance distortions) do not exceed the sub-angle (degrees) range. For example, we would like to distinguish occasionally two pairs of stars an with angular distance gap of 0.1, but pairs with an angular distance gap of 0.01 should be considered identical. The AL parameter analysis, may be defined as follows:

The AL parameter is a number between 0 and 1. This parameter is predefined and will dictate the way we save the star triplets in the hash map.

The AL parameter is a rounding value that multiplies each distance in the BSC before creating a key.

A well defined AL will determine the algorithm probability to pull star sets from the map and identify them. The lower this parameter is set, the lesser the probability that each key is unique. On the other hand, a low AL value will increase the probability of retrieving a key with a distorted value.

In all, the higher the accuracy, the greater the chance of missing similar patterns in the image frame. We consider this to be a good trade-off. Before determining the best AL to use, we performed some tests on the YBS to simulate different scenarios.

The First Test was done by counting the values for each key under various ALs. We used the BSC database to create the hash table. The graph depicted in FIG. 7 represents the probability of finding a star pattern of size 3 corresponding to the AL. For example, for an AL figure down to 0.2 (load factor of ≈1), there is only a single candidate for each triplet; however, for an AL of 0.065, the load factor is ≈8.5.

The AL parameter should be set after considering the system constraints. Denote “LoadFactor” to be the ratio between the total number of triangles in the hash table and the number of unique keys. For example, if a large distortion due to bad weather, wide angle lens distortion (in particular wide FOV lens), inaccurate calibration or atmospheric distortion is expected, then we would set the AL to be lower than 0.2. However, if we expect almost no distortion, then we can set the AL higher and reduce the algorithm runtime.

In the Second Test, we measured the effect the distorted distances have on the AL parameters. We also simulated different distance errors for every two stars in the BSC with different ALs. The distance errors were set by using Gauss's probability distribution model.

For each two stars sᵢ, sⱼ, sₜ, expected deviation err and AL, we created a key:

keyₑ(sᵢ,sⱼ,sₜ)=sort(∪_{i,j=1}^{k}Round(distance((sᵢ−sⱼ)+randGaus(err)*AL))) (4)

where:

randGaus(err) is a random value with Gauss normal distribution with mean value of 0 and standard deviation is the error expected. We also created a real key:

keyᵣ(sᵢ, sⱼ, sₜ)=sort(∪_{i,j=1}^{k}Round(distance((sᵢ−sⱼ))*AL) (5)

The results show that to obtain over 0.8 probability, which is achieved by retrieving the right value from the BSC with error probability of 0.5, the AL can be close to 1. However, in case the error probability is 8, we will have to set the AL to 0.015625 to get 0.7 probability in order to retrieve the correct value.

Empirical experiments in Section 4.1 hypothesized the distance gaps may be up to 1.5 due to camera lens distortion and atmospheric effect alone. Therefore, the AL parameter has to be set to a maximal value of ≈0.1 in uncalibrated cameras.

Hence, an improved star-identification algorithm should handle a case of multiple results for each key due to the large impact factor required to handle large distortions.

### Camera Calibration Effect

When discussing a distance gap, there is a need to consider the camera calibration effect. Camera calibration should reduce the gap to a minimum by transforming the image pixels to “real world” coordinates. Two factors affect frame distortion: Radial distortion, caused by light rays bending nearer to the edges of a lens than the optical center tangential distortion, and a result of the lens and the image plane not being parallel. In our case, we considered only the radial distortion because the stars are so far that their angles to the camera are almost parallel.

Because we used mobile device cameras with wide FOV, the radial distortion on the frame edges can cause distortion in distance calculations. For this reason, we expected more accurate results after camera calibration. This means that distances of the stars in the frame should be calculated according to the camera calibration parameters (focal length, center and three radial distortion parameters) after the frame is undistorted. However, experiments showed that even calibrated frames have a distance deviation of ½. We tested the distance in 8 frames of 2 stars taken from different angles before and after we undistorted the frames using a calibration parameter. We used Matlab calibration framework to calibrate and undistort the frames.

In FIG. 10A-B, we see the calibration reduce the distance gap. However, the gap still exists. These results emphasize the need for an algorithm that can overcome the distance deviation. We can also rely on the fact that we know the real angular distance between two stars (from the BSC) and use it to calibrate the scene after first identifying and obtaining more accurate orientation.

Due to the distance gap and the need to reduce calculations in real time, we propose a hash map model of star triplets with the addition of a rounding parameter. This model should help real-time orientation calculation.

### The Real-Time Algorithm (RTA)

To minimize search time on the YBS while improving efficiency, we used hashing as described elsewhere herein. Algorithm 4 searches star patterns of size 3. However, the algorithm can be expanded to work any star pattern of size >2. This algorithm will run after the construction of SPHT.

Following is pseudocode of an stars identification improved algorithm for star tracking.

ALGORITHM 4: Stars Identification Improved Algorithm

```
      Result: A matching between a set of pixels pᵢ ∈ F to stars sᵢ ∈ YBS
For each star set Pᵢ in Frame: Pᵢ =< p₁,p₂,p₃ >∈ Frame.
k =key < p₁,p₂,p₃ >
v[ ] =get values from SPHT where key is :k
if v is empty then
confidence(Pᵢ,null) = 0
end
else
    for each value in v do
    setConfidence(Pᵢ,vᵢ)
    end
end
return < p₁,p₂,p₃ > with confidence(< Pᵢ,vᵢ >)
```

Algorithm 4 assigns each star triplet in the frame with its matching star triplet from the catalog. For each match, the algorithm also sets the confidence parameter (number between 0 and 1).

There may be times when we want to utilize low AL in SPHT construction; for example, in bad weather, we should expect the distances to be inquorate. In such cases, we can obtain more than one set of stars from our hash table, and the algorithm will have to decide which set is the true match. The algorithm we present here suggests a solution for when the SPHT algorithm returns more than one set of matches. Note that:

The algorithm will run where for each pixel triangle: <p₁, p₂, p₃> of stars on the frame there are two or more matches <m₁, . . . mₙ>, where mᵢ is three stars from the catalog<sᵢ, sⱼ, sₖ> so that: L(<pᵢ, pⱼ, pₖ>)=<sᵢ, sⱼ, sₖ>∈ BSC.

In other words, for every star pᵢ there are some matches <mᵢ, . . . mⱼ>

we define:

A table SM that will hold the possible matches L(pᵢ) (labels) for each star in the pᵢ frame (retrieved from SPHT).

Confidence confidence (p, L(p) parameter will be added to each star pixel and labeled <pᵢ, sᵢ> in the frame.

This part of algorithm will determine the best pixel in the frame to use for tracking. The algorithm will return a star and its label with the highest confidence. Another way to think of this is to search the stars that appear in the highest number of triangle intersections. The confidence parameter range and its lower threshold will be discussed in the results section. The algorithm will get an array of stars pixel triangles and their possible labels ISM=∪₀ⁿ<L(p_{i,j,k}, L(p₁) . . . L(pₖ)> as input. This algorithm is the implementation of the setConfidence method described in the previous algorithm 4.

Following is pseudocode of an best match confidence algorithm for star tracking.

ALGORITHM 5: Best match confidence Algorithm

```
    Result Confidence c for each match < p,L(p) >∈ SM with its
confidence.
Create a temporary table SM of size n.
for each p in ISM do
    for each l in L(p) do
        add l to SM[p]
    end
end
for each p in SM do
    set the Confidence(p,l) to be the number of times the label with
maximum appearance appears
end
return each < p,L(p) > with its c(< p,L(p) >)
```

FIG. 11 and FIG. 12 visually explain the confidence calculation process.

The star-labeling algorithm may be utilized to track celestial objects. This implementation may be for airplanes or telescope-satellite tracking. In case such implementation is required, we can set the algorithm to track the outliers instead of the stars because they are already labeled.

### Validating and Improving the Reported Orientation

The RTA reports the most suitable identification for each star in the frame and the confidence of this match. However, due to significant inaccuracies and low AL values, there is a need to validate the reported orientation. Moreover, the accuracy of the orientation can be improved using an additional fine-tuning process incorporating all available stars in the frame. The validation stage may be seen as a variant of a Ransac method in which the main registration algorithm identifies two or more stars. According to those stars, the frame is being transformed to the BSC coordinates. Then each star in the transformed frame is being tested for its closest neighbor (in the BSC). The overall RMS over those distances represents the expected error estimation. The validation algorithm 6 performs the following two operations. It (1) Validates the reported orientation and (2) Improves the accuracy of the RTA orientation result. In order to have a valid orientation (T₀), at least two stars from the frame need to be matched to corresponding stars from the BSC. The validation process of T₀ is performed as follows:

ALGORITHM 6: Validation algorithm for the reported orientation

```
        Result: The orientation error estimation
        Input: S,T₀: S a set of all the stars in current frame. T₀ the
    reported RTA orientation.
    1 Let S_{T}₀ = S′ be the stars from S transformed by T₀.
    2 For each star s′ ∈ S′ search for its nearest neighbor b′ ∈ BSC,
let L < s′,b′ > be the set of all such pairs.
    3 Perform a filter over L - removing pairs that are too far apart
(according to the expected angular error).
    4 ErrorEstimation = the weighted RMS over the 3D distances
between pairs in L.
        return ErrorEstimation
```

To implement the above algorithm, the following functionalists should be defined:

Nearest Neighbor Search. This method may be implemented using a 3D Voronoi diagram, where the third dimension is the intensity/magnitude of the star.

Weighted RMS. This weight of each pair can be defined according to the confidence of each star in the frame.

The weighted RMS value is then used as an error-estimation validation value. In case we have a conflict between two or more possible orientations, the one with the minimal error estimation will be reported.

Finally, the validated orientation can be further improved using a gradient descent in which the estimation error should be minimized.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### EXAMPLES

Reference is now made to the following examples, which together with the above descriptions illustrate some embodiments of the invention in a non-limiting fashion.

### Example 1

### Distance Gap Experiment

To examine the distance gap, the inventors picked 40 frames from the Orion star constellation for testing. The frames were taken at different locations in different countries and weather conditions. As explained elsewhere herein, those conditions have been known to affect the angular distance of two stars as seen from earth. The purpose of this test was to learn how large this distortion would be and to implement it on the inventors algorithm. The experiment was split into two parts. In each part, the inventors checked the difference between the distances of every two stars on several frames.

Part 1. Testing star images taken in the same time and place to see the effect light distortion has on the tracking algorithm. Only one frame was used as base data for the following frames on the video.

Part 2. Testing star images taken at different times and places to help adjust the LIS algorithm mode for first detection.

The frames analysis was conducted in four steps:

1. Star image processing: the inventors extracted each of the stars' center pixel into a 2D array F₁, F₂=<s₁, . . . , sₙ>, <t₁, . . . tₙ> of size N,

2. Manually matched the stars from each frame F₁, F₂,

3. Calculated the pixel distances for each pair sᵢ, tᵢ ∈ F_{1,2} in every frame to two distances sorted as array D₁ and D₂ and

4. Calculated and returned the maximum gap of each pair distance for all i Gᵢ=dᵢ ∈ D₁−dᵢ ∈ D₂

These tests confirmed the inventors presumption that the distance gap between two frames can be quite large. The inventors noticed a gap as big as 1.5 between frames from different locations.

FIG. 13 provides an example of two frames of the Orion constellation from different locations. The red dots represent the stars' centers from one frame; and the blue dots, from another frame. This demonstrates that the gap between two similar stars (in circle) can be very large.

In addition, the inventors saw that the gap increased with distance. FIG. 14 shows the result of the distance gap experiments on the invenorts frames. FIG. 14 shows that the larger the distance between the stars (in two frames), the larger the gap can be. It also shows that, for close stars, the gap can be under 0.3 degrees.

### Example 2

### Simulation Results

To test the algorithm's correctness, a simulation system was created. The system fabricates a synthetic image from a set of random coordinates from the database using the orthogonal projection formula via a Stellarium system. In order to simulate real-world scenarios, the system also fabricates “noisy” frames by shifting some star pixels and adding some outlier stars. The output image is a close approximation of the night sky as seen from Earth. The pix/deg ratio of the simulated frames was 74.922, similar to most COTS cameras on which the algorithm will be implemented.

The first part of the simulation tested the first mode of the tracking algorithm (LIS mode). The tests focused on the following five parameters in particular:

The minimum AL needed for identification, confidence testing, dealing with outliers and false-positive stars in the frame, and the algorithm's runtime in each scenario.

Accuracy Level Parameter

In Example 1, the inventors showed that the distance gap can be very large. However, a small gap between the stars' distances also exists (under 0.26) for more ≈10% of the stars in the frames. There are several reasons for this gap besides the atmospheric effect because the frame was taken manually and with no camera adjustments. Naturally, the inventors also saw that the distance gap is affected by its length. The simulation's results show the minimum AL needed to get the keys from the database is 0.01. This means that the average number of triangles for each key is 3 (see Measurement error and Accuracy Figure section described elsewhere herein).

The inventors tested the algorithm with an AL of 0.01 on several simulated frames with possible gaps of 0.2-1.5 to see the percent average of matching stars. The algorithm was able to correctly label an average of 25% of the stars. The inventors stretched the algorithm boundaries by adding up to 0.25% outliers to the frame, so as to not affect the results. Interestingly, the number of real stars on the frame influenced the algorithm's success. That is, the algorithm was able to identify and match more stars because there were more real stars on the frame. Whereas an AL of 0.01 on this algorithm has a probability of 0.25 to set a star label, the right labels had high confidence in the results. This observation is highly important to the algorithm's LIS mode. This is because the LIS algorithm requires only 2 stars to determine primary orientation. Note that after the first identification, we can also elevate the AL parameter because two close frames should have a small gap and give more accurate results. The confidence parameter of each of star is a value represented by the amount of triangles retrieved from the database that contains the star match. In conclusion, the accuracy level required for earth-located star tracking is 0.01.

The inventors simulated the SPHT algorithm on several simulated stars frames with artificial gap (0-1.5) and discovered that the algorithm was able to set the right label for 25% of the stars. Although not optimal, this result can be useful especially in the LIS mode because the confidence of the results was very high.

Confidence Testing

The algorithm's confidence parameter plays a crucial part in deciding whether one or more of the stars on the frame was correctly identified. The inventors added this parameter to the algorithm to solve the problem of retrieving many keys for each star triplet in case of low AL. In this case, one needs to consider the triplet's “neighbors” in the frame and let them “vote” for each star label. The label that receives the highest confidence value is most likely to be true. However, it is not inevitable that the highest confidence match is wrong.

Analyzing the calculated confidence for each star in the frame reveals that this parameter is heavily dependent not only on the AL parameter of the algorithm, but also on the number of keys the algorithm managed to retrieve from the database. Because the confidence of a star also depends on the number of “real” stars in the frame, we computed it as the ratio between the number of possible triangles that point to this label and the stars in the frame.

The Star Confidence parameter is defined by ALGORITHM 4 described elsewhere herein, but we normalized this parameter to depend on the AL and the amount of triangles retrieved from the SPH algorithm in the following manner:

For each star,

$${s}_{i} ∈ F , Confidence ( {s}_{i} ) = \frac{T}{Num}$$

with T being the number of all the triangles retrieved from the SPHT for this frame, F and Num are the number of stars in that frame. As explained elsewhere herein, true labels should have more than one triplet. Therefore, the inventors expected the right matches in the frame to have a confidence of 2 or more. The inventors experimented with this theory on our simulated frames, testing frames with between 15 to 25 stars and frames that contained outliers.

FIG. 15 shows that the confidence parameter threshhold for a correct match in a frame with 20% outliers and 0.2 gap is ≈1.8. This means that if the SPHT algorithm identified a star match with confidence 1.8 or more, then this match is true and the inventors can calculate the frame orientation based on this result. In higher ALs, the inventors obtained a lower threshold for true matching. FIG. 15 shows that the confidence parameter threshold for the correct match in a similar frame is under 1.

Another observation was that frames with 10% or less outliers have lower thresholds. However, because one cannot predict the number of outliers the frame has, one cannot relay on a low threshold in the LIS scenario.

Simulation Runtime

The algorithm was able to compute a complete identification for the synthetic images. The average runtime in the case of clean stars was 1.2 milliseconds per image.

TABLE 1
Simulation Runtime Table.

| AC | Stars | Triangles | Runtime (ms) |
|---|---|---|---|
| 0.1 | 15 | 18.5 | 16.7 |
| 0.1 | 20 | 23.8 | 28.11 |
| 0.05 | 25 | 228.3 | 41.65 |
| 0.05 | 20 | 250 | 37.85 |
| 0.01 | 18 | 1007 | 341 |
| 0.01 | 21 | 1393 | 408.72 |
| 0.01 | 25 | 2388 | 740.75 |

Table 1 presents the algorithm's runtime (in milliseconds) on different AL and various numbers of stars in the frame. The average runtime is not influenced by the algorithm results, meaning the ability of the algorithm to identify the stars does not depend on the time this algorithm requires to run. The algorithm will require more time when the AL parameter is low (under 0.05) because the algorithm search predicted more triangles in case the AL was low.

### Example 3

### Field Experiments

To evaluate the performance of the proposed algorithm, the inventors conducted a set of field experiments. A preliminary version of the suggested algorithm was implemented as an Android app and tested on several Android smartphones. The main goal was to show that the proposed algorithm can work in real time on COTS devices which are not stationary (all images were captured while the phones were held in hand). At the first stage of the experiment, the inventors simply tried to capture stars. FIG. 17 shows the ability of an Android device to detect stars in real time (5-10 fps video in 1080p resolution, full high definition; FHD).

After having the ability to capture stars in real time, the application converts the star image to a list of star pixels. This list is fed to the algorithm that computes the star registration, as shown in FIGS. 18A-18D in which the registration was performed with respect to the YBS star data set. The star catalog (YBS) gives the stars' positions, like any celestial object, in an equatorial coordinate system, meaning right acceleration and declination. Therefore, the inventors first had to convert the stars' angular distances as they appeared in the catalog to the pixels in the frame before the hashing process; the inventors did so using the transformation described elsewhere herein.

FIG. 19 shows a star polar coordination system as implemented in the popular Stellarium software.

FIGS. 18A-18D shows the algorithm labeling process. The number near each match represents the confidence that the algorithm has attached to this match. Only matches with relatively high confidence are actually true matches. The confidence threshold for a correct match in this case was 2.75, and the AL parameter was relatively low because we expected light pollution to cause measurement inaccuracies.

Finally, there is a need to discuss the accuracy of the results given possible inaccuracies in image processing. In this experiment, the inventors used a simple super resolution to find each star-pixel center (in subpixel). Note that the average angular size of a star in the frame was [0.1,0.2] degrees. FIGS. 22A-22B depicts the typical way stars appear on the frame. The image process will allow us to improve the orientation accuracy about a single pixel

$$( \frac{1}{50} degree ) .$$

Finally, the SPHT algorithm can improve the accuracy to a subpixel AL

$$( lower than \frac{1}{100} degrees )$$

using multiple star matching and through time. The calculation of the star pixel can be done with great accuracy using one of the star-centroid algorithms. Such algorithms can improve the star center to subpixel accuracy, which was shown to be as accurate as 0.002 degrees. The inventors conclude that the suggested algorithm was able to reach a pixel-level

$$( \frac{1}{50} degree )$$

true orientation accuracy on calibrated smartphones.

### Example 4

### Implementation Remarks

The first major implementation challenge regarding the construction of a COTS star tracker is to find a platform capable of shooting stars. Intuitively, the inventors would like to use a platform capable of detecting stars at least as well as a human does. The Google Nexus 5x was the first device the inventors were able to use to detect starts in real time (see FIG. 17). Later, the inventors found that the Galaxy S6 produces better star images.

A preliminary set of experiments tested the algorithm ability for fast tracking by comparing two real night-sky images. One image was used as a dataset reference, and the other as taken by the camera. The frames were taken from different locations at different times and under different weather conditions. The inventors chose the Samsung's Galaxy S6 camera to take these photos with no calibration or modification. The inventors expected the distance gaps to be between 0.5 and 1.5. These preliminary experiments showed that the angular star-distance errors might get larger than 1.5 but, in most cases, 1 degree was a common expected error for uncalibrated smartphones. In such cases, an AL of (0.01) was shown to be a more proper value for the AL parameter. The expected accuracy of the reported orientation is highly correlated with the quality of the camera calibration, which can be a somewhat complicated process in practice. The inventors found the BoofCV was the best tool for calibrating Android cameras.

The inventors found the Android smartphones such as Galaxy S7 (and above) are great candidates for star tracking. FIGS. 18A-18D demonstrates the ability of the Galaxy S7 to capture high quality star images, even in the relatively suboptimal conditions of city light pollution, full moon and local lights. Note: the images in figure were taken using auto mode while holding the phone in hand. Based on the ever-improving quality of phone cameras, the inventors believe that by the end of 2018, most mid-range phones will be suitable for star tracking in terms of image quality.

Recent mobile phones allow better detection of the stars in the night sky since they are more sensitive to light. One example of such mobile device is the “Samsung Galaxy S9”. FIG. 22A-22B represent the algorithm result on star images as captures by this device. Since the lens of this device is relatively calibrated and therefore the frame is less distorted, the inventors were able to detect and named most of the star in the frame with AL of 0.05 and more.

A set of experiments was done using a Raspberry Pi, with a standard RP v2.0 camera. FIGS. 23A-23C show images captured with this camera. These images were taken on cloudy nights with light pollution, yet the algorithm was able to name the stars and detect the accurate angle.

An additional set of experiments was done using a star tracking device. FIGS. 24A-24G show images captured with such device. The device was able to detect 50 to 200 stars, using some image improvement algorithms.

What is claimed is:

1. A method for celestial navigation, the method comprising using at least one hardware processor for:
receiving at least one digital image at least partially depicting at least three light sources visible from at least one sensor, wherein the at least one sensor captured the at least one digital image;
processing the at least one digital image to calculate image positions of the depicted at least three light sources in each image;
identifying the at least three light sources in each image by comparing a plurality of geometric parameters computed from the at least three light sources and a respective plurality of geometric parameters computed from a database of light sources; and
determining a position of the at least one sensor based on the identified at least three light sources.

2. The method according to claim 1, wherein the at least one digital image is at least in part a frame of a video stream, a video file, or a live video cast.

3. The method according to claim 1, wherein the plurality of geometric parameters are at least one of an angle, a solid angle, a distance, and a geometric relationship.

4. The method according to claim 1, wherein the at least one sensor is a member of the group consisting of an optical sensor, a camera sensor, an electromagnetic radiation sensor, an infrared sensor, and a two-dimensional physical property sensor.

5. The method according to claim 1, wherein the light source is from a member of the group consisting of a roadway light, an astronomical body, a man-made space object, and a man-made aerial object.

6. The method according to claim 1, wherein the position is at least one of a location, an orientation, a distance, and a geometric relationship.

7. The method according to claim 1, wherein the position comprises at least one positioning value.

8. The method according to claim 1, wherein the at least one hardware processor is incorporated into at least one system selected from the group consisting of a laser aiming system, an antenna aiming system, a camera aiming system, and a position computation system.

9. The method according to claim 1, wherein the actions of the method are performed when global navigation satellite systems are unavailable for positioning.

10. A system for star tracking comprising:
at least one hardware processor; and
a non-transitory computer-readable storage medium having program code embodied therewith, the program code executable by said at least one hardware processor to:
receive at least one digital image at least partially depicting at least three light sources visible from the at least one sensor, wherein the at least one sensor captured the at least one digital image;
process the at least one digital image to calculate image positions of the depicted at least three light sources in each image;
identify the at least three light sources in each image by comparing a parameter computed from the at least one image and a respective parameter computed from a database; and
determine a position of the at least one sensor based on the identified at least three light sources.

11. The system according to claim 10, wherein the at least one digital image is at least in part a frame of a video stream, a video file, or a live video cast.

12. The system according to claim 10, wherein the plurality of geometric parameters are at least one of an angle, a solid angle, a distance, and a geometric relationship.

13. The system according to claim 10, wherein the at least one sensor is selected from the group consisting of an optical sensor, a camera sensor, an electromagnetic radiation sensor, an infrared sensor, and a two-dimensional physical property sensor.

14. The system according to claim 10, wherein the light source is selected from the group consisting of a roadway light, an astronomical body, a man-made space object, and a man-made aerial object.

15. The system according to claim 10, wherein the position is at least one of a location, an orientation, a distance, and a geometric relationship.

16. The system according to claim 10, wherein the position comprises at least one positioning value.

17. The system according to claim 10, wherein the system is selected from the group consisting of a laser aiming system, an antenna aiming system, a camera aiming system, and a position computation system.

18. The system according to claim 10, wherein the program code is executed when global navigation satellite systems are unavailable for positioning.

19. A computer program product for star tracking, the computer program product comprising a non-transitory computer-readable storage medium having program code embodied therewith, the program code executable by at least one hardware processor to:
receive at least one digital image at least partially depicting at least three light sources visible from the at least one sensor, wherein the at least one sensor captured the at least one digital image;
process the at least one digital image to calculate image positions of the depicted at least three light sources in each image;
identify the at least three light sources in each image by comparing a parameter computed from the at least one image and a respective parameter computed from a database; and
determine a position of the at least one sensor based on the identified at least three light sources.

20. The computer program product according to claim 19, wherein the at least one digital image is at least in part a frame of a video stream, a video file, or a live video cast.

21. The computer program product according to claim 19, wherein the plurality of geometric parameters are at least one of an angle, a solid angle, a distance, and a geometric relationship.

22. The computer program product according to claim 19, wherein the at least one sensor is selected from the group consisting of an optical sensor, a camera sensor, an electromagnetic radiation sensor, an infrared sensor, and a two-dimensional physical property sensor.

23. The computer program product according to claim 19, wherein the light source is selected from the group consisting of a roadway light, an astronomical body, a man-made space object, and a man-made aerial object.

24. The computer program product according to claim 19, wherein the position is at least one of a location, an orientation, a distance, and a geometric relationship.

25. The computer program product according to claim 19, wherein the position comprises at least one positioning value.

26. The computer program product according to claim 19, wherein the at least one hardware processor is comprised in a system selected from the group consisting of a laser aiming system, an antenna aiming system, a camera aiming system, and a position computation system.

27. The computer program product according to claim 19, wherein the program code is executed when global navigation satellite systems are unavailable for positioning.
